(19) United States
(12) Patent Application Publication
(10) Pub. No.: US 2018/0265405 A1
(43) Pub. Date: Sep. 20, 2018

(54) TREATED OIL SAND WASTE FOR USE IN CEMENTITIOUS MATERIALS FOR GEOTECHNICAL APPLICATIONS

(71) Applicant: THE UNIVERSITY OF WESTERN ONTARIO, London (CA)

(72) Inventors: Mohamed Hesham EL NAGGAR, London (CA); Ahmed SOLIMAN, Montreal (CA); Moustafa ABOUTABIKH, London (CA); Mahmoud KASSEM, New Cairo (EG); Ahmed MNEINA, London (CA)

(21) Appl. No.: 15/923,008

(22) Filed: Mar. 16, 2018

Related U.S. Application Data
(60) Provisional application No. 62/473,098, filed on Mar. 17, 2017.

(51) Int. Cl. C04B 18/04; C04B 7/02

(52) U.S. Cl. CPC C04B 18/049; C04B 7/02

(57) ABSTRACT

Oil sands drill cuttings waste represents one of the most difficult challenges for the oil sands mining sector. Reducing the amount oil sands drill cutting waste sent to landfill offers one of the best solutions for waste management. The present disclosure provides cementitious formulations comprised of treated oil sand waste for use in geotechnical applications. The cementitious formulations include but are not limited to grouts, cement and controlled low strength materials (CLSM) and in these formulations the treated oil sand waste (TOSW) is used to replace conventional constituents such as some of the fly ash in concrete, some of the cement in grout formulations and some of the fly ash and cement in the controlled low strength materials. The treated oil sand waste is predominantly silicon dioxide (SiO₂) which is produced using a process and system which separates water and oil from the solid waste, known as the thermos-mechanical cuttings cleaner (TCC).

### FIELD

The present disclosure relates to cementitious formulations which incorporate treated oil sand waste (TOSW) which is mostly silicon dioxide. Such cementitious formulations include but are not limited to grouts, concrete and controlled low strength materials (CLSM) and in these formulations the treated oil sand waste (TOSW) is used to replace conventional constituents.

### BACKGROUND

There are many cementitious formulations used in geotechnical applications including, but not limited to, grouts, concrete and controlled low strength materials (CLSM). Each of these cementitious formulations, as presently formulated, have various drawbacks associated with them. For example, concrete requires a flowability enhancer to help wet concrete to flow smoothly while being dispensed through long pipes such as is the norm at large constructions sites. Currently a preferred flowability enhancer used in concrete mixtures is fly ash, which is a by-product of coal combustion, is composed of fine particles which include substantial amounts of amorphous and crystalline silicon dioxide (SiO₂), calcium oxide (CaO) and aluminum oxide (Al₂O₃), and it has been used to replace some of the Portland cement in concrete production. However, with the shutting down of coal fired plants in the western world, it is becoming problematic to predictably source fly ash.

Controlled low strength materials (CLSM) typically consist of a mixture of Portland cement, water, aggregate and sometimes fly ash. While ordinary concrete typically has strengths exceeding 21 MPa, CLSM formulations have lower strength generally less than 8.3 MPa. Thus, while CLSM formulations are not suitable for structural supports, they are typically used as a replacement for compacted backfill. As with concrete, the use of fly ash is becoming problematic. CLSM mechanical properties have been deliberately kept low so that it can be excavated easily. However, due to its pozzolanic nature, the use of fly ash to maintain high flowability will increase later ages strength making re-excavation a problem.

Similarly, grout formulations are characterized as being a fluid form of concrete used to fill gaps and is typically a mixture of cement, sand and water. In geotechnical applications, Portland cement-based grouts are used to stabilize soil, remediate sinking structures, underpin existing foundations, construct earth support walls, construct groundwater cut-off walls and fill unwanted voids, such as below slabs-on-grade or within abandoned pipes and tunnels.

Typical Portland cement formulations use cement with a standard size of around 15 microns. However, in some applications these particles are too large to get the degree of compactness that would most beneficial for the application. Producing grout formulations with a finer particle sizes let the grout penetrate more deeply into a fissure.

It would be very advantageous to provide cementitious formulations having constituents selected to address the above noted limitations, and which provide the same or better end product properties of strength, flowability etc. while still meeting, or exceeding the functional requirements of the geotechnical applications for which the cementitious formulation is intended for.

### SUMMARY

Oil sands drill cuttings waste represents one of the most difficult challenges for the oil sands mining sector. Reducing the amount oil sands drill cutting waste sent to landfill offers one of the best solutions for waste management. The present disclosure provides cementitious formulations comprised of treated oil sand waste for use in geotechnical applications. The cementitious formulations include, but are not limited to, grouts, concrete and controlled low strength materials (CLSM) and in these formulations the treated oil sand waste (TOSW) is used to replace conventional constituents such as some of the fly ash in concrete, some of the cement in grout formulations and some of the fly ash and cement in the controlled low strength materials. The treated oil sand waste is predominantly silicon dioxide (SiO₂) which is produced using a process and system which separates water and oil from the solid waste, known as the thermos-mechanical cuttings cleaner (TCC).

The present disclosure provides a method of producing cementitious formulations, comprising:

subjecting oil sands drill cuttings to a process configured for
separating water and hydrocarbons from solid constituents of the oil sands drill cuttings, and
producing treated oil sands waste comprising solid SiO₂ particles having a size distribution in a range from about 0.8 to about 30 microns, and with about 90% of the sample volume below about 9.9 microns; and

mixing said solid SiO₂ particles with constituents used in preselected cementitious formulations used in a preselected geotechnical application.

The process configured for separating water and hydrocarbons from solid constituents of the oil sands drill cuttings is carried out in a thermos-mechanical cuttings cleaner.

The solid SiO₂ particles may have a mean size of about 2.7 microns.

The preselected cementitious formulation may be a grout formulation to be mixed with water, and wherein the grout formulation may comprises a mixture of at least cement and water, and wherein the solid SiO₂ particles are used to replace at least some of the cement.

The solid SiO₂ particles may be used to replace the cement in an amount between about 10 to about 50% by volume.

The preselected cementitious formulation is a grout formulation to be mixed with water, and wherein the grout formulation comprises a mixture of at least cement, sand and water, and wherein the solid SiO₂ particles are used to replace at least some of the cement and sand. In this aspect the solid SiO₂ particles may be used to replace the cement in an amount between about 10 to about 30% by volume, and to replace the sand in an amount between about 10 to about 20% by volume.

The preselected cementitious formulation may be a grout formulation comprising cement to be mixed with water, and wherein the solid SiO₂ particles are used to replace cement from about 0% to about 50% by volume.

The preselected cementitious formulation may be a concrete formulation to be mixed with water, and wherein the concrete formulation comprises a mixture of at least cement, aggregates and fly ash, and wherein the solid SiO₂ particles are used to replace at least some of the fly ash.

The preselected cementitious formulation may be a concrete formulation to be mixed with water, and wherein the concrete formulation comprises a mixture of at least cement, aggregates and fly ash, and wherein the solid SiO₂ particles are used to replace all of the fly ash such that the cementitious formulation for the concrete formulation includes cement, aggregates and the solid SiO₂ particles.

The preselected cementitious formulation may be a concrete formulation to be mixed with water, and wherein the concrete formulation comprises a mixture of at least cement, aggregates and fly ash, and wherein the solid SiO₂ particles are used to replace at least some of the fly ash and some of the cement.

The preselected cementitious formulation may be a concrete formulation to be mixed with water, and wherein the concrete formulation comprises a mixture of at least cement, aggregates and fly ash, and wherein the aggregates include sand and gravel, and wherein the solid SiO₂ particles are used to replace at least some of the fly ash, some of the sand and some of the cement.

The preselected cementitious formulation may be a concrete formulation to be mixed with water, and wherein the concrete formulation comprises a mixture of at least cement, aggregates and fly ash, and wherein the aggregates include sand and gravel, and wherein the solid SiO₂ particles are used to replace at least some of the sand and some of the cement, and all of the fly ash.

The preselected cementitious formulation may be a concrete formulation to be mixed with water, and wherein the concrete formulation comprises a mixture of at least cement, course aggregates, fly ash and sand, and wherein the solid SiO₂ particles are used to replace the sand by about 0 to about 40% by volume, and some or all of the fly ash.

The preselected cementitious formulation may be a controlled low strength material to be mixed with water, and wherein the controlled low strength material comprises a mixture of at least cement, and fine aggregates, and wherein the solid SiO₂ particles are used to replace at least some of one or both of the cement and fine aggregates.

The preselected cementitious formulation may be a controlled low strength material to be mixed with water, and wherein the controlled low strength material comprises a mixture of at least cement, fine aggregates, and fly ash, and wherein the solid SiO₂ particles are used to replace at least some of one or all of the cement, fly ash and fine aggregates.

The preselected cementitious formulation may be a controlled low strength material to be mixed with water, and wherein the controlled low strength material comprises a mixture of at least cement, sand, and fly ash, and wherein the solid SiO₂ particles are used to replace sand by about 0 to about 15% by volume and fly ash by 100%.

The present disclosure provides a cementitious formulation produced by the method disclosed above and comprises:
treated oil sands waste in an amount of about 10 to about 40% by weight, said treated oil sands waste comprising solid SiO₂ particles having a size distribution in a range from about 0.8 to about 30 microns, and with about 90% of the sample volume below about 9.9 microns; and
cementitious constituents.

A further understanding of the functional and advantageous aspects of the present disclosure can be realized by reference to the following detailed description and drawings.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1a shows a scanning electron micrograph (SEM) image of a particle of the treated oil sand waste (TOSW) produced using the thermo-mechanical cuttings cleaner (TCC) technology disclosed in (Ormeloh, 2014);

FIG. 1b shows an energy dispersive X-ray analysis (EDX) for the TOSW particle of FIG. 1a;

FIG. 2 shows the particle size distribution using Laser diffraction for ordinary Portland cement (OPC) and TOSW;

FIG. 3 shows the effect of TOSW replacement rate on cement paste water of consistency;

FIG. 4 shows the effect of TOSW replacement rate on cement paste heat flow;

FIG. 5 shows heat of hydration with adapted reference curves for cement pastes incorporating different percentage of TOSW;

FIG. 6 shows DTG curves for cement pastes incorporating different percentages of TOSW;

FIG. 7 shows compressive strength results for mixtures incorporating different percentages of TOSW at different ages;

FIG. 8 shows reduction in compressive strength due to TOSW incorporation at different ages;

FIG. 9 shows results for measured shrinkage for mixtures incorporating different percentages of TOSW;

FIG. 10 shows results for measured mass loss for mixtures incorporating different percentages of TOSW;

FIG. 11 shows pore size distribution for mixtures incorporating different percentages of TOSW;

FIG. 12 shows a followability and water/powder ratio chart for CLSM formulations;

FIG. 13 shows bleeding results as percentage of volume for the CLSM formulations;

FIG. 14 shows drying shrinkage for G260 and G290 mixtures;

FIG. 15 shows the results of ICP-MS analysis showing effect of curing days on Group 2 leachates samples;

FIG. 16 shows the results of an ICP-MS analysis showing results of 28 days of curing on Group 2 and Group 3 mixtures;

FIG. 17 shows the development of compressive strength with age of Group 2 and Group 3 selected mixtures;

FIG. 18 shows the linear relationship between split tensile strength and compressive strength;

FIG. 19 is a photograph of cementitious grout incorporating TOSW;

FIG. 20 shows a plot of slump variation for all tested concrete specimens over the investigated time period;

FIG. 21 shows a plot of compressive strength development for all tested concrete mixtures over the investigated time period;

FIG. 22 shows a plot of splitting tensile strength development for all tested concrete mixtures over the investigated time period;

FIG. 23 is a plot showing correlation between the experimental data and predicted values for the splitting tensile strength;

FIG. 24 is a plot of flexural strength development for all tested concrete mixtures over the investigated time period;

FIG. 25 is a plot showing the correlation between the experimental data and predicted values for the flexural strength;

FIG. 26 is a plot showing modulus of elasticity development for all tested concrete mixtures over the investigated time period;

FIG. 27 is a plot showing the correlation between the experimental data and predicted values for the modulus of elasticity;

FIG. 28 is a plot showing pull-out strength development for all tested concrete mixtures over the investigated time period;

FIG. 29 is a bar graph showing compressive strength and pull-out strength of the tested concrete mixtures at age 28 days as percentage of the control mixture;

FIG. 30 is a bar graph showing durability factor for different concrete mixtures; and

FIG. 31 is a plot showing corrosion current through the test time for different formulations.

### DETAILED DESCRIPTION

Various embodiments and aspects of the disclosure will be described with reference to details discussed below. The following description and drawings are illustrative of the disclosure and are not to be construed as limiting the disclosure. The drawings are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions.

As used herein, the term “grout” refers to a composition which generally includes the following constituents Portland cement, water, fine aggregate and sometimes chemical admixtures, pozzolanic additive and filler materials.

Grouts are used in geotechnical applications including stabilizing soil, remediating sinking structures, underpinning existing foundations, constructing earth support walls, constructing groundwater cut-off walls and filling unwanted voids, such as below slabs-on-grade or within abandoned pipes and tunnels.

As used herein, the term “concrete” refers to a composition which generally includes the following constituents Portland cement, water, fine and course aggregate and sometimes chemical admixtures, pozzolanic additive and filler materials.

As used herein, the phrase “controlled low strength materials (CLSM)” refers to a composition which generally includes Portland cement, water, aggregate and sometimes fly ash.

Oil sands industry is a major driver for economic activity in Canada. Concurrently, solid waste generated by oil sands mining sector has serious environmental and ecological impacts. Oil sand drill cuttings solid waste represents one of the main challenges for the oil sand mining sector. Reducing the amount of oil sand drill cutting solid waste sent to landfill sites offers an efficient solution for waste management. Many technologies have been developed to treat these cuttings and reduce the amount of waste to be landfilled. One of the recent technologies is Thermo-Mechanical Cuttings Cleaner (TCC), which separates water and oil from the solid waste as disclosed in Ormeloh, 2014, and which is incorporated herein by reference in its entirety. In this pre-treatment technique, drill cuttings solid waste is thermally treated to recover hydrocarbons. The TCC system operates by converting kinetic energy to thermal energy in a thermal desorption process thereby transforming drilling waste into re-usable products. A significant advantage of using kinetic energy rather than indirect heating allows for short retention times with the result being the quality of the separated components is unaffected by the treatment. The by-product of the TCC process (i.e. the remaining solids) is very fine quartzes powder, is referred herein as Treated Oil Sand Waste (TOSW).

U.S. Pat. No. 8,607,894 discloses a TCC system and this patent is incorporated herein by reference in its entirety.

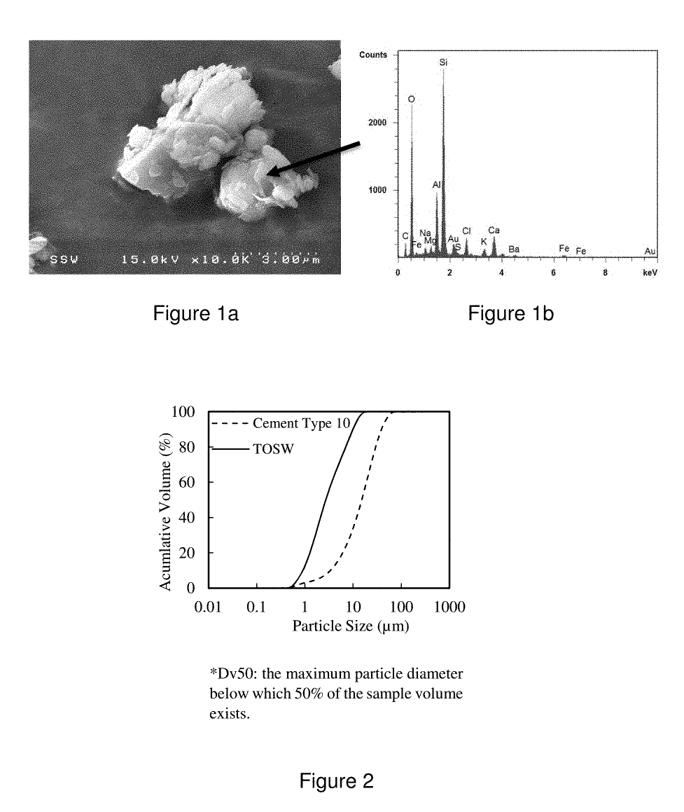

The TOSW particles used in the formulations disclosed herein, once obtained where subject to characterization studies. FIG. 1a shows a scanning electron micrograph (SEM) image of a particle of the treated oil sand waste (TOSW) produced using the thermo-mechanical cuttings cleaner (TCC) technology disclosed in Ormeloh and FIG. 1b shows an energy dispersive X-ray analysis (EDX) for the TOSW particle of FIG. 1a from which it can be seen the TOSW particles are predominantly SiO₂. FIG. 2 shows the particle size distribution using Laser diffraction for ordinary Portland cement (OPC) (broken line) and TOSW (solid line) and as can be seen the TOSW SiO₂ particles have a size distribution between about 0.8 to about 30 microns, and with a about 90% of the sample volume below 9.9 microns. The mean size of TOSW SiO₂ particles is about 2.7 microns.

The various cementitious formulations produced according to the present disclosure using SiO₂ particles isolated from oils sands residue using the TOSW process will now be illustrated for grout formulations, concrete and controlled low strength materials, but it will be understood these are exemplary and not meant to be interpreted as limiting.

### Grout Formulations

Chemical compositions for OPC and TOSW used in the present grout formulations were obtained through X-ray diffraction and are provided in Table 1. The grain size distribution curves for OPC and TOSW are shown in FIG. 2 as noted above.

TABLE 1
Chemical composition and physical properties of
cementitious materials.

| Types | OPC | TOSW |
|---|---|---|
| Chemical analysis | | |
| SiO₂ | 21.60 | 61.24 |
| Al₂O₃ | 6.00 | 8.73 |
| Fe₂O₃ | 3.10 | 3.00 |
| CaO | 61.41 | 5.55 |
| MgO | 3.40 | 0.92 |
| K₂O | 0.83 | 1.60 |
| Na₂O | 0.20 | 0.85 |
| P₂O₅ | 0.11 | 0.15 |
| SO₃ | 1.76 | 3.00 |
| TiO₂ | — | 0.46 |
| Loss on Ignition | 0.81 | 12.60 |

A total of five (5) mixtures were tested to assess the effect of TOSW addition on the cementitious materials performance. The different mixtures were achieved by varying TOSW contents in the tested mixtures from 0%, 10%, 20%, 30% to 50% as a partially replacement of cement (i.e. by volume as TOSW is typically less dense than cement). Table 2 provides a summary for tested mixtures composition.

TABLE 2
Composition for tested mixtures.

| | TOSW % | | | | |
|---|---|---|---|---|---|
| Materials | 0% | 10% | 20% | 30% | 50% |
| Cement | 400 g | 360 g | 320 g | 280 g | 200 g |
| TOSW | — | 28 g | 57 g | 85 g | 142 g |
| Water | 168 g | 167.81 g | 168.21 g | 168.03 g | 168.24 g |

### Tests and Specimens Preparation

All tested cement paste mixtures were prepared according to ASTM C305 (Standard Practice for Mechanical Mixing of Hydraulic Cement Pastes and Mortars of Plastic Consistency). For each cement paste mixture, specimens for different tests were prepared from the same batch. After casting, specimens were maintained at ambient temperature (i.e. 23±1° C.) and covered with polyethylene sheets until demolding to avoid any moisture loss. Immediately after demolding, specimens were moved to a moist curing room (Temperature=23±1° C. and relative humidity=98%) until the testing age.

The effect of TOSW addition on water demand for normal consistency was evaluated according to ASTM C187 (Standard Test Method for Amount of Water Required for Normal Consistency of Hydraulic Cement Paste). In addition, the effect of TOSW addition on cement reactivity was monitored through measuring the heat of hydration for each cement paste mixture and setting time according to ASTM C191 (Standard Test Methods for Time of Setting of Hydraulic Cement by Vicat Needle). Cubic specimens (50×50×50 mm) were used to determine the compressive strength at ages 7, 28 and 90 days according to ASTM C109 (Standard Test Method for Compressive Strength of Hydraulic Cement Mortars [Using 2-in. or (50-mm) Cube Specimens)]. Prismatic specimens (25×25×280 mm) were used for evaluating drying shrinkage following ASTM Method C490 (Standard Practice for Use of Apparatus for the Determination of Length Change of Hardened Cement Paste, Mortar, and Concrete). Identical size specimens were used to measure the mass loss in order to dispel the effect of the specimen size on the results.

Thermo-gravimetric analysis was also conducted on selected cement paste samples to assess the development of their microstructure. Cubic specimens of size 50×50×50 mm were prepared for leaching test. Collected leachate samples were analyzed every 3 days up to 18 days using inductively coupled plasma mass spectrometry (ICP-MS). Cement paste fragments were taken from tested specimens and immediately plunged in an isopropanol solvent to stop hydration and subsequently dried inside a desiccator until a constant mass was achieved. The pore size distribution for each specimen was determined automatically using a Micromeritics AutoPore IV 9500 Series porosimeter.

### Results and Discussion

### Water of Consistency

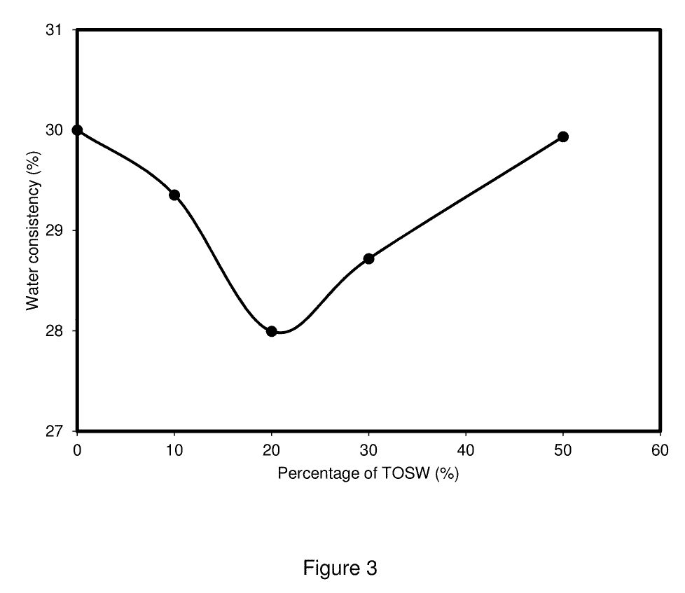

FIG. 3 shows the water of consistency, which represents the amount of water required to achieve a normal consistency for all tested cement paste mixtures incorporating different percentages of TOSW. Results reveal that the water of consistency for tested cement paste mixtures slightly decreases as the percentage of TOSW increases. However, increasing the TOSW dosage higher than 20% results in a lower reduction in the water of consistency. For instance, paste mixtures incorporating 20% and 30% of TOSW had exhibited a reduction in the water demand for normal consistency with about 6.7% and 4.3% than that of the pure OPC paste mixture. This can be attributed to two compensating effects induced by TOSW: TOSW is a very fine material, hence, addition of such fine particles will increase the specific surface area of the powder, leading to a higher water demand to achieve a given consistency.

Simultaneously, TOSW small particles size enhances the packing density of powder and reduce the interstitial void, thus decreasing entrapped water between cement particles and making it available leading to a lower flow resistance. Therefore, the controlling factor for which one of the compensating effects will dominate the behaviour mainly depends on the particle size of the used fine material. In this study, the addition of 20% TOSW can be considered as the threshold value and is highly dependent on its particle size. At TOSW addition rate below 20%, the increase in water demand is compensated by the reduction in flow resistance leading to a lower water of consistency. Conversely, as the TOSW addition rate exceeds 20%, the increase in water demand dominates the behaviour leading to a higher water of consistency. Also, higher free water is expected in mixtures incorporating TOSW, as TOSW addition was found to enhance formation of monocarboaluminate hydrate that needs less water than that of ettringite as will be discussed later.

### Heat of Hydration

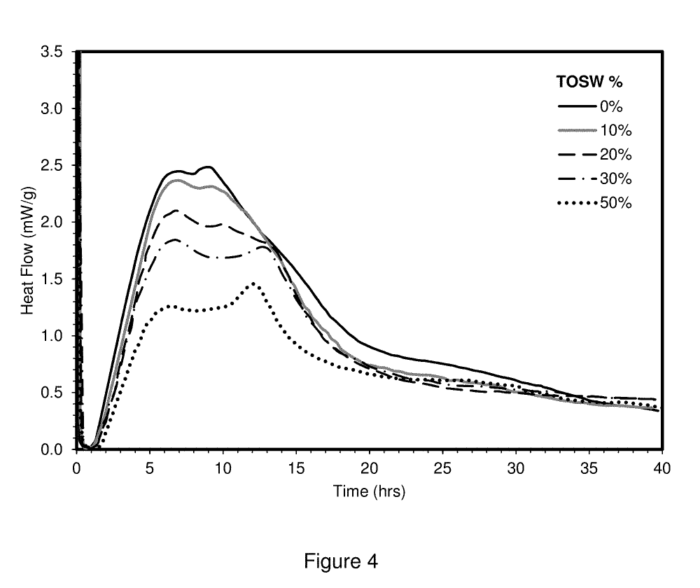

FIG. 4 illustrates the effect of TOSW addition of cement hydration through monitoring the heat liberation for pure cement paste and paste mixtures incorporating different percentages of TOSW as a partial replacement of cement. It is clear that adding TOSW as a partial replacement of cement reduces the hydration heat. The higher the replacement rate of cement by TOSW, the greater the reduction in the main hydration peak. This can be attributed to the dilution effect. Generally, once water and cement come in contact, cement wetting and hydration of free lime cause initial rapid heat liberation, resulting in a peak within the first 1-2 min. The second peak of hydration curve, the so-called “silicate peak” is related to the rapid hydration of tricalcium silicate (C₃S) and the precipitation of portlandite (CH). A third hydration peak can occur as a result of calcium carboaluminates formation from the reaction between limestone and aluminates from C₃A existing in the OPC.

In order to characterise the differences between the control paste mixture and other pastes, an adapted reference curve was plotted. This curve is obtained by multiplying the curve values of the control paste by 100% minus the respective incorporation rate of TOSW of the composition under consideration. Hence, the effect of cement substitution with an inert material (i.e. TOSW) is simulated. Theoretically, the substitution of cement with an inert material decreases the hydration heat since it is normalised with respect to the mass of binder. This actually results in a lower heat flow per gram of binder.

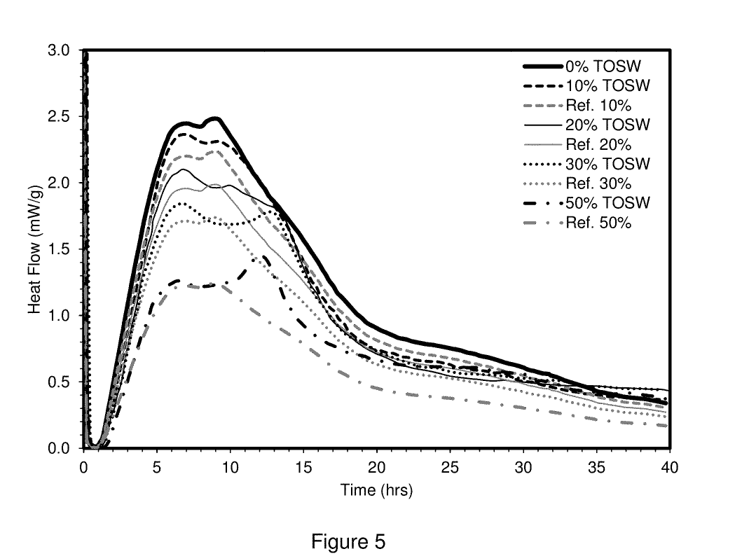

FIG. 5 represents the adapted reference curves and the curves with actual substitutions of mineral additions. The magnitude of the main peak of the cement pastes with TOSW is slightly greater than the peaks of the adapted reference curves. For instance, cement paste mixture incorporating 20% TOSW exhibited a 7.60% higher heat flow peak than that of the adapted curve based on 20% substitution percentage (i.e. Ref. 20%). However, a chemically inert behaviour does not mean that the hydration kinetics cannot be influenced and only retarded due to the dilution effect. The chemically inert mineral additions in mortars can alter the degree of hydration. This can explain the increase in the slopes of hydration curve during the acceleration periods (i.e. slopes of heat flow curves up to the second peak), which can be regarded as indicators of nucleation effect (Table 3). These results were confirmed by setting time results which showed a slight variation in the measured setting time. For instance, the initial setting time setting time for all tested cement paste mixtures ranged between 2.68 hrs and 2.93 hrs. Moreover, changes in the value and location of the third peak are more pronounced as TOSW addition rate increases.

TABLE 3
Slopes of heat flow curves during the acceleration periods for tested mixtures

| | 10% | Ref- | 20% | Ref- | 30% | Ref - | 50% | Ref - |
|---|---|---|---|---|---|---|---|---|
| Curves | TCCW | 10% | TCCW | 20% | TCCW | 50% | TCCW | 50% |
| Slope | 0.51 | 0.48 | 0.49 | 0.43 | 0.42 | 0.37 | 0.30 | 0.27 |

| | | | | |
|---|---|---|---|---|
| Increase (%) | 6% | 14% | 14% | 11% |

FIG. 4 shows that as the percentage of TOSW increases the third peak starts to decrease at its original location along with the occurrence of a shoulder after the third heat peak. Moreover, at high percentage of TOSW, the third peak is noticeable at around 18 hrs which is correlated with the hydration of C₃A. This can be explained as follows: TOSW addition enhances and accelerates the ettringite formation by offering nucleation sites. Hence, higher amount of C₃A is consumed leading to depletes of aluminates. Simultaneously, TOSW represents another source for aluminates, which will react with limestone to form calcium carboaluminates. This was confirmed by thermogravimetric analyze for selected cement paste samples.

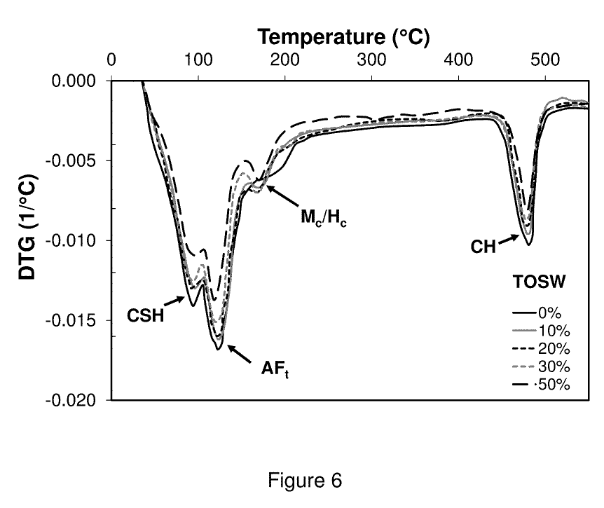

In thermogravimetric analyzer, the change in mass of a sample placed in a controlled atmosphere is continuously recorded. Thus, decomposition and water loss from hydration products are observed and quantified. The derivative thermogravimetric curves (DTG) allow identifying different decomposition processes as shown in FIG. 6. Four peaks can be distinguished on DTG curves. Weight loss associated to the loss of combined water of calcium silicates hydrates (CSH) (peak 1), ettringite (AFₜ) (calcium aluminate hydrates) (peak 2), decomposition of mono- (M_{c}) and hemicarbonate calcium aluminate (H_{c}) (peak 3). Weight loss peak that occurs at temperature range 450-500° C. is related to the dehydroxilation of portlandite (CH) (peak 4). It is clear that the intensity of the endothermic peak for M_{c}/H_{c} increases as the amount of TOSW increases which implies the increase in M_{c}/H_{c} formation.

### Compressive Strength

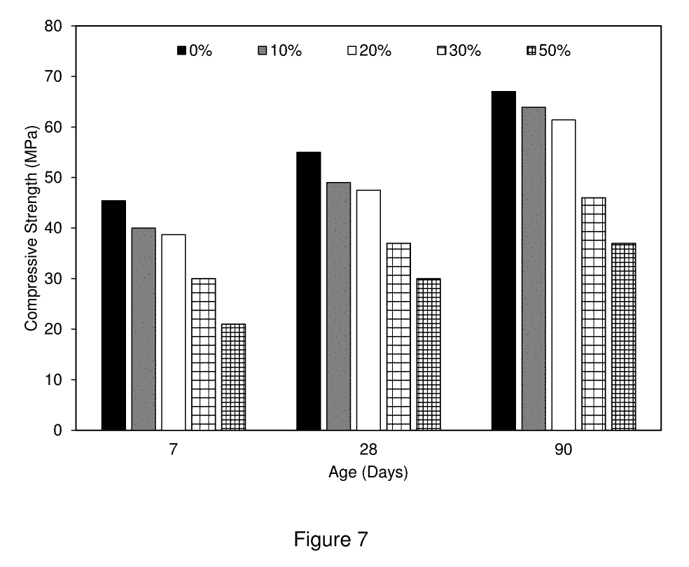

FIG. 7 shows the compressive strength results for mixtures incorporating different percentages of TOSW. Generally, the compressive strength had increased for all paste mixtures with time. However, addition of TOSW resulted in some reduction in the achieved compressive strength; the higher the TOSW, the greater the reduction in the compressive strength. For instance, mixtures incorporating 10% and 30% of TOSW as a partial replacement of cement exhibited 12% and 34% reduction in the 7 days compressive strength with respect to that of the control mixture. This can be explained based on both dilution and filler phenomena. At early ages, the strength development rate depends mainly on the rate of hydration and formation of hydration products. Addition of a fine filler to cement modifies the early hydration rate primarily due to dilution effect. Replacing cement by TOSW decreases the total cement content leading to a lower formation for hydration products. However, the large specific surface of the TOSW small particles increases its potential as nucleation sites that promote the precipitation of hydration products.

Although nucleation is a physical process, it accelerates the hydration process of cement. This can partially compensate for the reduction in the hydration rate due to the dilution effect. Consequently, at low replacement rates (i.e. 10%), the dilution effect will have lower influence on strength development than at high replacement rates (i.e. 30%). This is in agreement with previous heat of hydration (FIG. 4) and DTG results (FIG. 5). At later ages, the rate of hydration is very slow and consequently the strength gain rate is low. On the other hand, at this later age, filler materials are able to reduce gaps and spaces needed to be filled by hydration products, which can compensate for the dilution effect leading to a recovery in the strength.

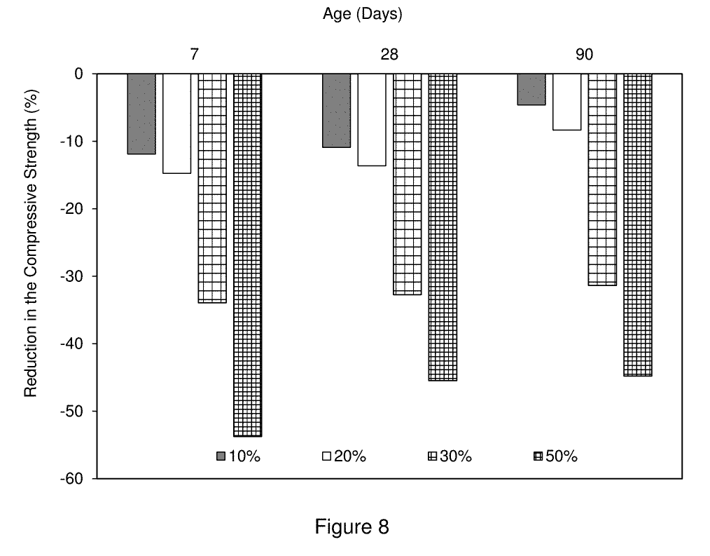

FIG. 8 shows the reduction in the compressive strength with respect to control mixtures at different ages. FIG. 8 indicates that the percentage reduction in compressive strength of the paste mixtures decreased as sample age increased. Moreover, it seems that partially replacing cement by TOSW with a rate higher than 20% causes significant reduction in the compressive strength. For instance, reductions in the compressive strength for mixtures incorporating up to 20% and more than 20% TOSW as partial replacement of cement were <15% and >30% regardless of the sample age, respectively. This indicates that the dilution effect in pastes with TOSW>20% will dominate, leading to a reduction in strength. It should be mentioned that even though the compressive strength decreased due to the addition of TOSW, it is still within the range for several construction applications. For example, in micropile applications, the Federal Highway Administration (FHWA) specified the minimum design compressive strength as 28 MPa for the gout used.

### Drying Shrinkage

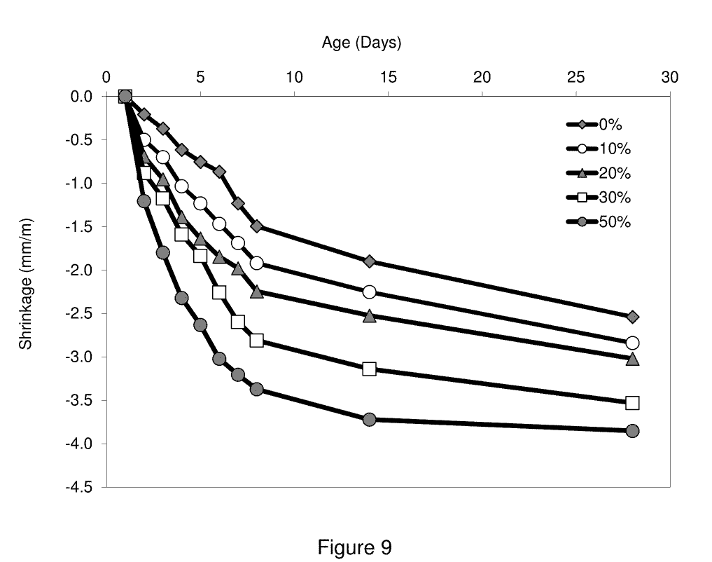

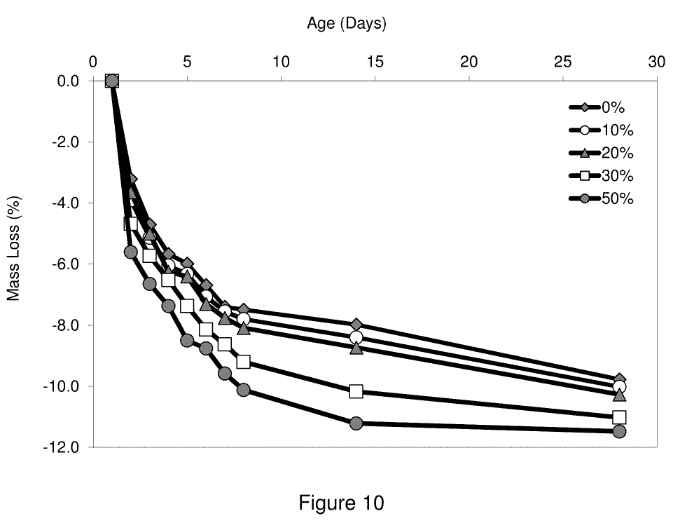

FIGS. 9 and 10 illustrate the drying shrinkage and mass loss results for mixtures incorporating different percentage of TOSW. Regardless of the percentage of TOSW, shrinkages and mass losses for tested cement paste mixtures incorporating TOSW are practically higher than that of the control mixture without TOSW, and the measured shrinkage was greater for mixtures with higher percentage of TOSW. For instant, mixtures incorporating 10% and 20% of TOSW as partial replacement of cement exhibited 11% and 19% higher shrinkage than that of the control at age 28 days, respectively. Thermal shrinkage of the cement paste mixture may be ignored due to the small size of the tested specimens which assure quick dissipation of the hydration heat. Therefore, shrinkage was mainly due to the evacuation of water from the test specimens.

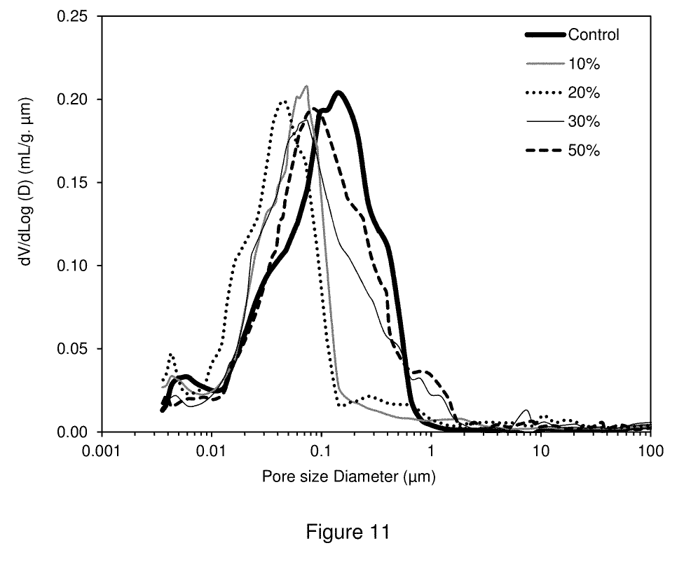

Hardened cement paste is a porous medium. The formation of the pore structure largely depends on the degree of hydration and water content. Pore structure provides an indication of the degree of interconnection between the pores and the pore size distribution in the hardened cement. From shrinkage point of view, capillary pores are the most important type of pores as their sizes will control the amount of internal tensile stresses and consequently shrinkage. The finer the capillary pores, the higher the shrinkage. Capillary pores are formed because the hydration products do not fill all the space between hydrated cement particles. Hence, the presence of TOSW will influence the microstructure of the cement paste including the total porosity and the critical pore diameter along with the connectivity of capillary pores and thus water exchange. Therefore, shrinkage and mass loss results can be explained based on the two concurrently effects induced by TOSW addition: Filling and diluting. Adding the TOSW, which is a very fine material, act as a filler leading to finer pores, which in turn leads to higher shrinkage. FIG. 11 shows the porosity measured for the tested mixtures. It is clear from FIG. 11 that the addition of TOSW had refined the pore sizes. Meanwhile, replacing cement with TOSW reduces the cement content leading to formation of lower amounts of hydration products.

Consequently, a lower amount of water is consumed in the hydration reactions, besides the depercolation/disconnection of capillary pores is delayed. Hence, more free water became available for evaporation and can easily find its path to the surrounding environment, leading to a higher mass loss, i.e. higher mass loss occurs as the TOSW percentage increases. For instant, mixtures incorporating 20% and 50% TOSW as a replacement of cement exhibited 5% and 29% higher mass loss than that of the control specimens at age 7 days, respectively. Thus, the measured shrinkage for the tested mixtures is attributed to the combined effects of: refined pores leading to higher capillary stresses and lower hydration product formation leading to greater availability of free water.

### Leaching

Based on the previous results, it seems that adding TOSW more than 20% as a partial replacement of cement will adversely affect the cementitious material performance. Therefore, the leaching test was conducted only on specimens incorporating 10% and 20% of TOSW as a partial replacement of cement. In order to identify the leaching properties of heavy metals that existed in the TOSW, leaching test was conducted on TOSW before being incorporated into the cementitious material. Table 4 shows the results of heavy metal leaching test for TOSW sample and cement paste samples incorporating 10% and 20% TOSW. It is clear that both tested cementitious samples with 10% and 20% TOSW showed a reduction in metal leaching compared to that of the raw TOSW sample. Moreover, metal leaching results was below groundwater standard of the Canadian Council of Ministers of Environment (CCME). For instance, leaching of Aluminum, Arsenic, Cadmium, Copper, Nickel, and Vanadium from cement mixtures incorporating TOSW was below CCME standards within the range of 22% to 96%. This can be attributed to the solidifying of the TOSW in the microstructure of the cementitious mixtures.

TABLE 4
Leaching test results of TCCW

| | | Raw | Cementitious material | |
|---|---|---|---|---|
| | | TCCW leaching | leaching (mg/l) | |
| Element | Symbol | (mg/l) | 10% TCCW | 20% TCCW |
| Silver | Ag | 0.005 | 0.002 | 0.001 |
| Aluminum | Al | 1.656 | 0.349 | 0.815 |
| Arsenic | As | 0.012 | 0.003 | 0.006 |
| Barium | Ba | 1.100 | 0.066 | 0.101 |
| Cadmium | Cd | 0.066 | 0.001 | 0.004 |
| Chromium | Cr | 0.006 | 0.003 | 0.004 |
| Copper | Cu | 0.012 | 0.007 | BDL* |
| Potassium | K | 80.580 | 3.586 | 24.84 |
| Lithium | Li | 0.013 | BDL* | BDL* |
| Magnesium | Mg | 4.852 | 0.571 | 0.39 |
| Manganese | Mn | 0.011 | BDL* | BDL* |
| Molybdenum | Mo | 0.056 | 0.005 | 0.005 |
| Sodium | Na | 116.358 | 1.746 | 6.438 |
| Nickel | Ni | 0.017 | 0.009 | 0.006 |
| Strontium | Sr | 3.604 | 0.059 | 0.123 |
| Vanadium | V | 0.038 | 0.018 | 0.026 |

*BDL: Below Detecting Limits

In addition, the fine particles of TOSW act as a filler decreasing the void spaces and blocking the pores and thus higher amount of metal is entrapped.

### Conclusions

The results disclosed herein show that employing TOSW as a construction material can represent an interesting and viable alternative to final landfill disposal. Based on the results of this study, the following conclusions can be drawn. First, water of consistency of cement paste mixtures slightly decreases as the percentage of TOSW increases. Secondly, as the proportion of TOSW in the mixture was increased, the compressive strength decreased; above 20% TOSW, the strength reduction was more than 30%. Therefore, it would be appropriate to use TOSW within 10% to 20% content by weight. Thirdly, addition of TOSW was found to induce higher shrinkage, hence, when using TOSW in cementitious materials, it would be appropriate to apply a shrinkage mitigation method (i.e. the use of shrinkage reducing admixture). This point needs further investigation. Lastly, the leaching tests carried out on cementitious mixtures incorporating TOSW confirmed that the process makes it possible to obtain materials with a pollutant potential lower than that characterizing the TOSW.

### CLSM Formulations

Controlled low-strength material (CLSM) is a flowable self-levelling cementitious material widely used as a replacement for soil-cement materials in many geotechnical applications such as structural backfill, pipeline beddings, void fill, pavement bases and bridge approaches. Because of its low strength requirements, CLSM can be a perfect host for many waste and by-products assuming that these materials have been proven environmentally safe. Many studies have evaluated the effect of incorporating different by-products, such as spent foundry sand, cement kiln dust, wood ash, scrap tire rubber and coal combustion by-products on the properties of CLSM. The main properties for CLSM performance are flowability, density, and compressive strength. However, other properties such shrinkage, bleeding and subsidence were also evaluated. The upper limit of compressive strength of CLSM can be up to 8 MPa, however, maintaining a low strength is essential for projects where later excavation is required. CLSM with a compressive strength of 0.7 MPa and lower can be easily excavated manually if there is no high content of coarse aggregate in the mixture. The removability modulus (RE) can be used to assess the excavatability of a CLSM mixture based on its strength and dry density (Equation 1).

$$RE = \frac{{W}^{1.5} \times 0.619 \times {C}^{0.5}}{{10}^{6}} \qquad ( 1 )$$

Where W is the dry density of the mixture in (kg/m³), C is the compressive strength at 28 days in (kPa). The CLSM mixture is considered easily removable if RE is less than one (1).

The present disclosure presents the potential of incorporating TOSW in CSLM as a fine filler material in order to produce green CLSM. Using TOSW as a fine filler will alter the properties of CLSM either chemically or physically, or both, therefore, it is important to evaluate the properties of the new CLSM to maintain the performance within the requirements of ACI committee 229 for different geotechnical applications.

### Materials

Type 10 Ordinary Portland Cement (OPC) with Blaine fineness of 360 m²/kg and specific gravity of 3.15 and Class F fly ash according to ASTM C618 were used as binding materials in CLSM mixtures. OPC contained 61% Tricalcium Silicate (C₃S), 11% Dicalcium Silicate (C₂S), 9% Tricalcium Aluminate (C₃A), 7% Tetracalcium Aluminoferrite (C₄AF), 0.82% equivalent alkalis and 5% limestone. Treated Oil Sand Waste (TOSW) was used as a silicate base fine filler material with a Blaine fineness of 1440 m²/kg and specific gravity of 2.23. The chemical composition and the physical properties of the cement, fly ash and TOSW are shown in Table 5.

TABLE 5
Chemical composition and physical properties of
cementitious materials

| | OPC | TOSW | Fly ash |
|---|---|---|---|
| Chemical | | | |
| Composition | | | |
| SiO₂ | 21.60 | 61.24 | 43.39 |
| Al₂O₃ | 6.00 | 8.73 | 22.08 |
| Fe₂O₃ | 3.10 | 3.00 | 7.74 |
| CaO | 61.41 | 5.55 | 15.63 |
| MgO | 3.40 | 0.92 | — |
| K₂O | 0.83 | 1.60 | — |
| Na₂O | 0.20 | 0.85 | 1.01 |
| P₂O₅ | 0.11 | 0.15 | — |
| SO₃ | 1.76 | 3.00 | 1.72 |
| TiO₂ | — | 0.46 | — |
| Physical | | | |
| properties | | | |
| Surface area | 360 | 1440 | 280 |
| (m²/kg) | | | |
| Specific gravity | 3.15 | 2.23 | 2.5 |

Three groups of mixtures were prepared and tested in the current study: Group 1 included control mixtures prepared based on proportion guidelines reported by ACI committee 229. All mixtures were mixed with natural river bed sand with a specific gravity of 2.65. Group 2 included six mixtures where TOSW was added as a partial replacement of sand by volume at rates of 5%, 10%, and 15%. Group 3 was comprised of nine mixtures prepared with TOSW as a replacement of 100% of the fly ash along with partial replacement of sand by volume at rates 5%, 10% and 15%. Mixture proportions are shown in Table 6.

TABLE 6
Mixtures proportions

| | Mixture | Cement | Fly ash | Aggregate | TOSW | Water | w/Powder¹ |
|---|---|---|---|---|---|---|---|
| | Code | kg/m³ | kg/m³ | kg/m³ | kg/m³ | kg/m³ | kg/m³ |
| (Group 1) | G130 | 30 | 148 | 1727 | 0 | 297 | 4.3 |
| Control | G160 | 60 | 148 | 1691 | 0 | 297 | 3.8 |
| Mixtures | G190 | 90 | 148 | 1655 | 0 | 297 | 3.4 |
| (Group 2) | G260W5 | 60 | 148 | 1606 | 84 | 221 | 1.9 |
| TOSW | G260W10 | 60 | 148 | 1522 | 168 | 226 | 1.5 |
| replacing | G260W15 | 60 | 148 | 1437 | 253 | 221 | 1.2 |
| aggregate | G290W5 | 90 | 148 | 1572 | 82 | 270 | 2.2 |
| | G290W10 | 90 | 148 | 1490 | 165 | 245 | 1.5 |
| | G290W15 | 90 | 148 | 1407 | 247 | 244 | 1.13 |
| (Group 3) | G330W5 | 30 | 0 | 1641 | 205 | 209 | 2.1 |
| TOSW | G330W10 | 30 | 0 | 1554 | 277 | 177 | 1.3 |
| replacing fly | G330W15 | 30 | 0 | 1468 | 350 | 165 | 1.0 |
| ash and | G360W5 | 60 | 0 | 1606 | 205 | 246 | 2.2 |
| aggregate | G360W10 | 60 | 0 | 1522 | 274 | 227 | 1.6 |
| | G360W15 | 60 | 0 | 1437 | 341 | 232 | 1.3 |
| | G390W5 | 90 | 0 | 1572 | 205 | 224 | 1.9 |
| | G390W10 | 90 | 0 | 1490 | 274 | 212 | 1.4 |
| | G390W15 | 90 | 0 | 1407 | 341 | 213 | 1.2 |

¹The ratio of water content to fly ash, cement and TOSW

### Mixing Procedure

Dry mixture components (i.e. cement, fly ash and TOSW) were mixed for 1 minute without addition of water to ensure a homogeneous distribution. About half of the mixing water was then added gradually to the mixture and mixed for 1 more minute and the rest of the mixing water was then added and mixed for another minute. The mixture was allowed to rest for 1 minute after adding the water and then mixed for another 2 minutes before sampling. No special admixtures were needed to adjust the properties of the mixture. The flowability of the mixture was continuously measured during the addition of water to reach the desired normal flowability range of 150 mm to 200 mm.

### Testing

Fresh properties, including flowability, unit weight and bleeding, were evaluated for fresh mixtures according to ASTM standards D6103-04 (Flow Consistency of Controlled Low Strength Material), ASTM D6023-07 (Density, Yield, Cement Content, and Air Content (Gravimetric) of Controlled Low-Strength Material) and ASTM test method C232 (Standard Test Method for Bleeding of Concrete), respectively.

To assess the effect of mixing materials on drying shrinkage, a drying shrinkage test was conducted following the ASTM test method C490-11 (Standard Practice for Use of Apparatus for the Determination of Length Change of Hardened Cement Paste, Mortar, and Concrete). Four 25 mm×25 mm×280 mm prismatic samples were prepared for each mixture. The prisms were kept in plastic bags for 7 days to reduce water evaporation. The samples were then demolded and the initial readings were taken before wrapping the samples in plastic bags and storing until testing ages. The shrinkage readings were taken daily until no change was recorded.

The compressive strength was determined as per ASTM test method D4832-10 (Standard Test Method for Preparation and Testing of Controlled Low Strength Material (CLSM) Test Cylinders). Due to the low early age strength of CLSM mixtures, samples were matured in their uncovered molds inside a 98% relative humidity curing room until testing ages. Compressive tests were conducted after 7, 14 and 28 days of mixing using a strain controlled unconfined compressive strength machine. The compressive loading was applied at a strain rate of 1.14 mm/min, which ensured that failure of the tested sample would not occur in less than 2 minutes (ASTM D 4832-10, 2010). The stress-strain curve was plotted and the secant elastic modulus was calculated as the slope of the line from origin to the point of 50% of maximum stress. The CLSM specimens were also tested for splitting tensile strength at age of 28 days following ASTM standards C496/C496M (Standard Test Method for Splitting Tensile Strength of Cylindrical Concrete Specimens).

The environmental assessment of incorporating TOSW in CLSM mixtures was evaluated by investigating heavy metals leaching from the hardened CLSM samples immersed in distilled water. As aforementioned, three different replacement rates of TOSW were used; however, environmental assessment was conducted only on samples having the highest content of TOSW, which is 15%, to represent the most critical impact of using TOSW as a fine material in CLSM mixtures. The results were compared with the groundwater standards of the Canadian Council of Ministers of Environment (CCME, 2004). In addition, tests were conducted on the raw TOSW separately in order to evaluate its leaching properties. Cubic samples of 50×50×50 (mm) were used following the procedure of method 1315 of the US Environmental Protection Agency (Mass Transfer Rates of Constituents in Monolithic or Compacted Granular Materials Using a Semi-Dynamic Tank Leaching Procedure). Leachates samples were collected after 2, 7 and 28 days of immersion in distilled water and analyzed using coupled plasma mass spectrometry (ICP-MS).

### Results and Discussion

### Flowability

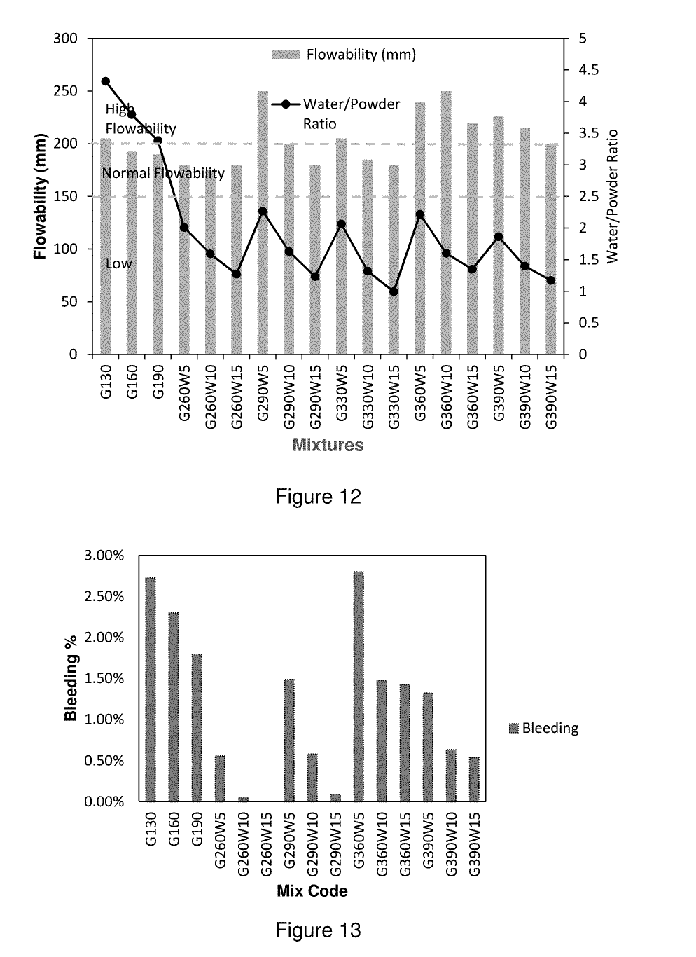

Flowability of CLSM mixtures is generally controlled by the amount of added water to achieve the targeted flow of 150 to 200 mm. Results show that changing the cement content while maintaining the same fly ash content has an insignificant effect on the flowability of CLSM, in agreement with previous work (Qian, Xiang, Qiao, Jianming, & Baoshan, 2015). FIG. 12 presents the results of the flowability for tested CLSM mixtures. The flowability of CLSM control mixtures ranged from 185 to 250 mm, which falls within the normal to high flowability category according to the ACI committee 229R report. The incorporation of TOSW reduced the amount of water required to achieve the same flowability range of control mixtures with about 25%.

As shown in FIG. 12, mixtures containing TOSW required considerably lower water/powder ratios while maintaining a normal flowability. Incorporating very fine material, such as TOSW, increases the surface area of the particles in the mixture, which leads to a higher water demand. On the other hand, the small particle size in TOSW enhances the powder packing and releases the water entrapped between cement particles making it available for lubrication and consequently increasing the flowability of the mixture. In addition to filling voids between coarser particles, the very fine TOSW acts as a “lubricant” between them, reducing the particle interference and consequently the viscosity. This was confirmed in Group 3 mixtures at which fly ash was replaced by TOSW. TOSW addition was more efficient in increasing flowability than fly ash (FIG. 12).

### Density

Density of the fresh and hardened CLSM samples were measured at different ages up to 28 days of curing. Table 7 presents the fresh and hardened density of the different tested mixtures. The fresh density of the control mixtures ranged from 2190 to 2195 kg/m³. It can be noticed from Table 7 that the density of Group 2 ranged from 1816 to 1901 kg/m³. This represents a reduction of density up to 17% compared to that of the control mixtures but the density still lies within the range of normal density CLSM mixtures reported by ACI Committee 229. The reduction in density can be attributed to the low specific gravity of TOSW compared with sand. For Group 3 mixtures, in which fly ash was replaced by TOSW, the fresh density increased up to 6% for G390 and G360 mixtures, then it started to decrease with age at a rate slower than Group 2 mixtures. The fresh density ranged from 2067 to 2325 kg/m³ for all Group 3 mixtures, which is also within the range of normal density CLSM mixtures.

TABLE 7
Fresh and hardened densities of CLSM mixtures

| | | Fresh | | | |
|---|---|---|---|---|---|
| | | Density | Hardened Density (kg/m³) | | |
| | Mixture Code | (kg/m³) | 7 days | 14 days | 28 days |
| (Group 1) | G130 | 2195 | 2201 | 2231 | 2226 |
| ACI-229R | G160 | 2190 | 2244 | 2218 | 2207 |
| Control | G190 | 2192 | 2217 | 2201 | 2207 |
| Mixtures | | | | | |
| (Group 2) | G260W5 | 1939 | 1872 | 1900 | 1897 |
| TOSW | G260W10 | 1901 | 1849 | 1846 | 1860 |
| replacing | G260W15 | 1928 | 1932 | 1935 | 1918 |
| sand | G290W5 | 1942 | 1963 | 1955 | 1935 |
| | G290W10 | 1816 | 1930 | 1913 | 1988 |
| | G290W15 | 1939 | 1935 | 1932 | 1952 |
| (Group 3) | G330W5 | 2087 | 1765 | 1774 | 1774 |
| TOSW | G330W10 | 2067 | 1677 | 1761 | 1761 |
| replacing fly | G330W15 | 2134 | 1785 | 1796 | 1796 |
| ash and | G360W5 | 2325 | 1977 | 1977 | 2002 |
| sand | G360W10 | 2214 | 1915 | 1930 | 1938 |
| | G360W15 | 2308 | 1990 | 1962 | 1968 |
| | G390W5 | 2249 | 1897 | 1927 | 1914 |
| | G390W10 | 2313 | 1946 | 1948 | 1947 |
| | G390W15 | 2302 | 1919 | 1934 | 1949 |

### Bleeding

Increasing the cement content reduced the bleeding in all mixtures as more water was consumed in hydration resulting in less free water. For instance, increasing the cement content in control mixtures from 30 to 90 kg/m³ reduced bleeding with about 34%. The bleeding results range matches the range found in the literature for CLSM mixed with fly ash. The settlement during placement was also measured based on volume reduction due to released water and entrapped air; the subsidence results ranged from 1.8% to 3.1%.

Mixtures with TOSW showed a significant reduction in bleeding ranging from 76% to ˜100% for G260 mixtures and from 17% to 95% for G290 mixtures and up to 17% and 70% for G360 and G390 mixtures compared with bleeding control mixtures as shown in FIG. 13. This reduction can be attributed to the increase in fine materials content in the mixture which is directly related to the water/powder ratio.

Incorporating waste that includes large amounts of fines (i.e. large surface area) increases the amount of water needed to cover the fine particles, which keeps water from escaping to the surface as bleed water during setting of the mixture. Bleeding values of all mixtures, however, were well below the maximum of 5% for stable CLSM.

### Drying Shrinkage

Drying shrinkage of all mixtures was measured as the change of the sample initial length. Measurements were taken until no significant change was recorded. Measurements for control mixtures G160 and G190 showed that increasing cement content reduced the shrinkage as the hydration products were increased, leading to less free water for evaporation.

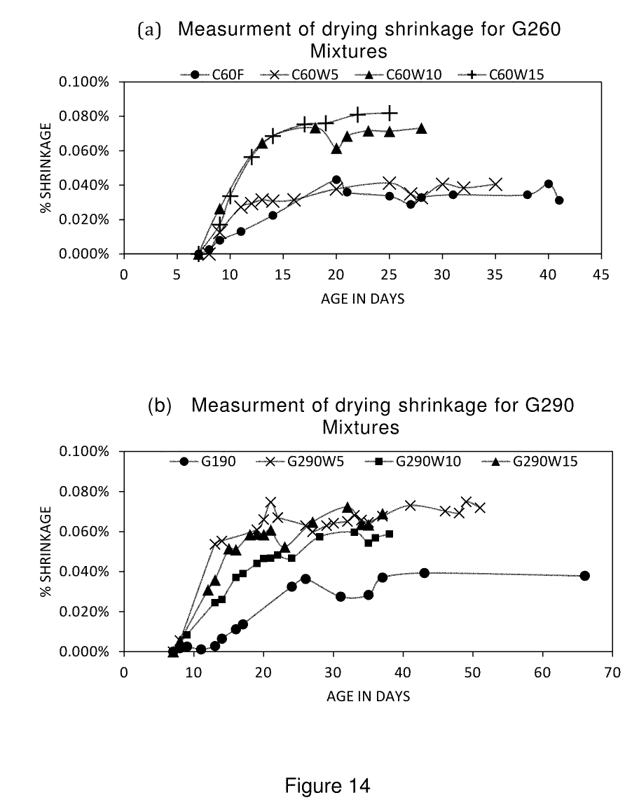

Mixtures containing TOSW experienced increases in shrinkage. For example, shrinkage of G260 and G290 (see FIGS. 14(a) and 14(b)) mixtures increased from 0.031% to 0.082% and from 0.038% to 0.072% compared to that of the control mixtures, respectively. This behaviour is related to the water/powder ratio and amount of bleeding observed. Mixtures with high bleeding values exhibited lower shrinkage as the water dried from the surface rather than from the bulk of the material.

Moreover, incorporating a fine inert material like TOSW refine capillary pores in the hardened mixtures, which increased the internal tensile stresses leading to more shrinkage.

The normal range of ultimate shrinkage in CLSM is between 0.02% and 0.05% (ACI Committee 229R, 2013). The range of the measured shrinkage for G260 mixtures exceeded the normal range for CLSM yet was still below the typical ultimate shrinkage of 0.1% for concrete. The mixture design can be optimized to keep the shrinkage closer to the lower limit (i.e. 0.031%). However, shrinkage has minor effect on the performance of CSLM (ACI Committee 229R, 2013).

### Leaching of Heavy Metals

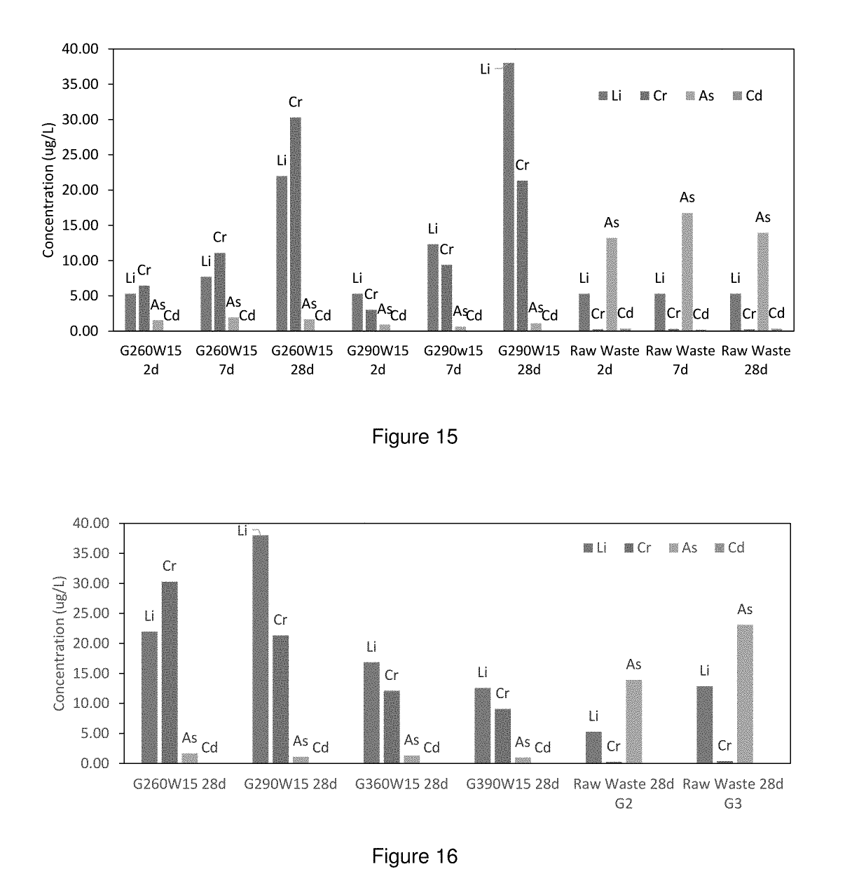

Table 8, FIGS. 15 and 16 show the results of the conducted (ICP-MS) analysis on the leachates. It is noticed from FIG. 15 that the TOSW has little to no contribution to the concentration of Lithium and Chromium of the leached material. The concentration of these metals increased with age only for mixtures containing cementitious materials, while measurements for the same elements in raw TOSW samples were within minimum detectable concentration. On the other hand, leaching of Arsenic, Strontium, Cadmium and Barium were prominent for the raw TOSW sample and greatly reduced for samples containing cementitious materials, which indicates stabilization of these elements in CLSM mixtures. However, concentration of Strontium and Barium were noticeably higher in Group 3 mixtures as the amount of cementitious materials reduced by replacing fly ash with TOSW. FIG. 16 shows a clear reduction in the concentrations of Lithium and Chromium for samples with TOSW as a replacement for fly ash (Group 3) compared with mixtures containing fly ash (Group 2) after 28 days of leaching. All leaching results were below the concentration limits of the groundwater standard of the Canadian Council of Ministers of Environment (CCME).

TABLE 8
Results of (ICP-MS) analysis of leachates

| | | Elements: | | | | | |
|---|---|---|---|---|---|---|---|
| | | Lithium | Chromium | Arsenic | Strontium | Cadmium | Barium |
| | | (Li) | (Cr) | (As) | (Sr) | (Cd) | (Ba) |
| | | Conc. | Conc. | Conc. | Conc. | Conc. | Conc. |
| Mix code | age | (μg/L) | (μg/L) | (μg/L) | (μg/L) | (μg/L) | (μg/L) |
| G260W15 | 2 days | 5.29 | 6.43 | 1.55 | 179.45 | ND | 153.45 |
| G260W15 | 7 days | 7.70 | 11.09 | 1.94 | 455.31 | ND | 146.11 |
| G260W15 | 28 days | 21.97 | 30.29 | 1.67 | 1148.03 | ND | 118.08 |
| G290W15 | 2 days | 5.29 | 3.03 | 0.93 | 81.40 | ND | 131.21 |
| G290W15 | 7 days | 12.32 | 9.38 | 0.64 | 480.47 | ND | 180.43 |
| G290W15 | 28 days | 38.03 | 21.32 | 1.11 | 977.09 | ND | 320.43 |
| G360W15 | 28 days | 16.86 | 12.10 | 1.31 | 3887.84 | <0.05 | 874.63 |
| G390W15 | 28 days | 12.58 | 9.07 | 0.98 | 3699.30 | <0.05 | 792.48 |
| Raw G2 | 2 days | <5.29 | <0.26 | 13.20 | 1040.43 | 0.34 | 394.81 |
| Raw G2 | 7 days | <5.29 | 0.32 | 16.74 | 1201.91 | 0.21 | 381.74 |
| Raw G2 | 28 days | <5.29 | <0.26 | 13.93 | 1485.15 | 0.33 | 477.06 |
| Raw G3 | 28 days | 12.85 | 0.38 | 23.09 | 1920.81 | 0.27 | 371.45 |

ND = lower than method detection limit

### Compressive Strength

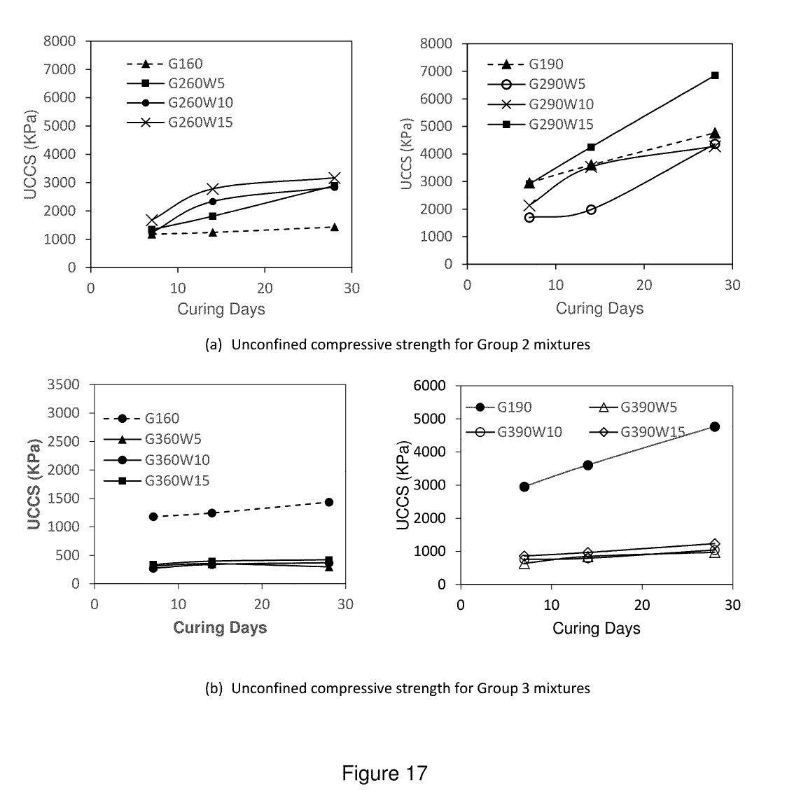

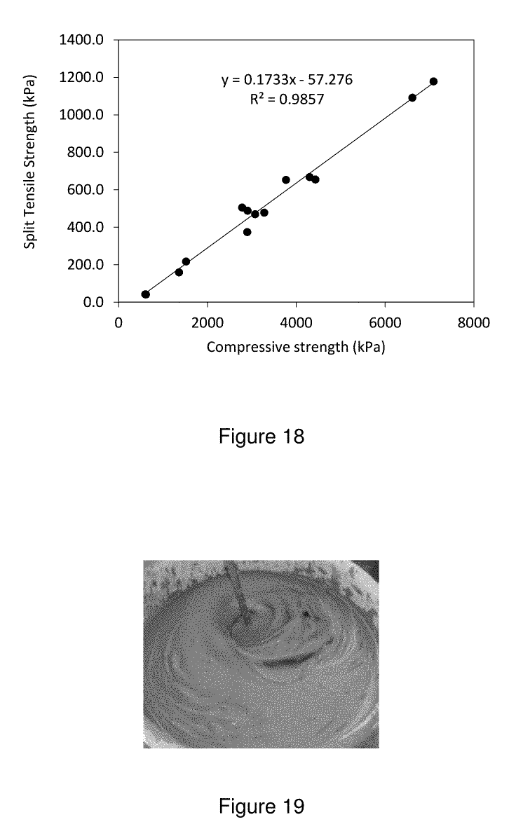

The compressive strength was evaluated for the three control CLSM mixtures and 15 CLSM mixtures with different cement, TOSW and fly ash contents, after 7, 14 and 28 days of curing. The compressive strength values of the tested mixtures are presented in Table 9 and FIGS. 17(a) and 17(b). Control mixtures with cement content of 30 and 60 kg/m³ (i.e. G130 and G160) exhibited a very slow strength gain rate compared with 90 kg/m³ mixture (G190). This can be attributed to the dilution effect and reduction in pozzolanic reaction of fly ash. The class F fly ash used in these mixtures has no cementitious properties and needs cement in order for the pozzolanic reaction to take place; in the presence of cement, the silicate minerals in fly ash react with the calcium hydroxide released during the hydration process of the cement.

For mixtures incorporating TOSW, the compressive strength depends mainly on the water/powder ratio. As shown in FIGS. 12 and 17(a), the strength of G290 mixtures increased with the decrease of water/powder ratio regardless of the waste content. However, in Group 2 mixtures, the ability of the TOSW to enhance flowability reduced the amount of water needed for the mixture, which led to an increase in strength when the same flowability was maintained as noticed for G260 mixtures. On the other hand, replacing fly ash with TOSW in Group 3 mixtures resulted in a significant reduction in strength. This is attributed to reduced bonding between particles due to the lack of the pozzolanic activity of fly ash that was available in Group 2 mixtures. However, this reduced strength can be compensated for by increasing the cement content. For example, increasing the cement content from 60 kg/m³ to 90 kg/m³, led to an increase in the achieved compressive strength of about 300% (i.e. from 423 kPa for G360 mixture to 1233 kPa for G390 mixture). In addition, for some CLSM applications, it may be important to maintain a low strength to facilitate future excavation. The ACI committee 229 recommends a compressive strength lower than 2.1 (MPa) if future excavation is anticipated (ACI Committee 229R, 2013).

CLSM cylinders were also tested for tensile strength according to ASTM test method C496/C496M (Standard Test Method for Splitting Tensile Strength of Cylindrical Concrete Specimens). FIG. 17 shows a good linear relationship between the tensile strength and the compressive strength of the tested CLSM samples. The tensile strength ranged from 7% to 17% of the compressive strength and this range is very close to the normal range of Portland cement concrete, which is 8% to 14% (Qian 2015).

To assess the excavatability of tested mixtures, the removability modulus is calculated according to (Equation 1) based on the results of the compressive strength and density of the samples. The requirements and limits of RE vary with the application of CSLM, CLSM is considered easily removable by hand tools if RE is equal or less than one (1). Replacing fly ash with TOSW lowered the RE producing more easily removable CLSM while maintaining the other properties of CLSM within ACI specifications. The results of removability modulus calculations are shown in Table 9.

### Elastic Modulus

The secant elastic modulus (Eₛ) was calculated based on the stress-strain curve obtained from the unconfined compressive strength test at 50% of the maximum strength at 28 days. The obtained results demonstrated that the secant elastic modulus increased as the compressive strength, as shown in Table 9. The secant elastic modulus was found to be 46 to 210 times the corresponding compressive strength which is within the range reported in the literature for CLSM.

TABLE 9
Compressive strength, elastic modulus and removability
modulus at age of 28 days

| | | | (UCCS) | | |
|---|---|---|---|---|---|
| | | (E) Modulus | Compressive | | |
| | Mixture | of Elasticity | strength | | |
| | code | (KPa) | (KPa) | E/UCCS | RE |
| (Group 1) | G130 | 73324 | 595 | 122 | 1.59 |
| ACI-229R | G160 | 65887 | 1436 | 46 | 2.43 |
| Control | G190 | 489235 | 4771 | 102 | 4.43 |
| Mixtures | | | | | |
| (Group 2) | G260W5 | 181647 | 2894 | 63 | 2.75 |
| TOSW | G260W10 | 360617 | 2840 | 127 | 2.65 |
| replacing | G260W15 | 322350 | 3172 | 101 | 2.93 |
| sand | G290W5 | 625374 | 4364 | 143 | 3.48 |
| | G290W10 | 280892 | 4281 | 66 | 3.59 |
| | G290W15 | 676029 | 6848 | 98 | 4.42 |
| (Group 3) | G330W5 | 3154 | 72 | 54 | 0.39 |
| TOSW | G330W10 | 20174 | 158 | 128 | 0.57 |
| replacing fly | G330W15 | 26749 | 184 | 146 | 0.64 |
| ash and sand | G360W5 | 18106 | 298 | 61 | 0.96 |
| | G360W10 | 48877 | 370 | 135 | 1.02 |
| | G360W15 | 88804 | 423 | 210 | 1.11 |
| | G390W5 | 57489 | 972 | 59 | 1.62 |
| | G390W10 | 119108 | 1043 | 114 | 1.72 |
| | G390W15 | 181206 | 1233 | 147 | 1.87 |

### Conclusions

The results of this study demonstrate that TOSW can be used as a filler material and as a replacement of fly ash in CLSM formulations producing a sustainable and environmentally safe CLSM that satisfies fresh and hardened properties. Moreover, some of the CLSM properties were enhanced after incorporating TOSW. There are several significant advantages of using TOSW in the CLSM formulations.

For example, the incorporation of TOSW has increased the flowability of the mixtures, which reduced the water demand to reach a specific flowability value, which in turn lead to higher compressive strength in Group 2 mixtures. TOSW was more effective in increasing flowability compared with fly ash in Group 3 mixtures.

Lower dry density was achieved for mixtures with TOSW, which makes it suitable for field applications encountering weak soils. Some of the mixtures can also be classified as Class VII low-density CLSM (LD-CLSM) according to ACI committee 229R, which makes TOSW a suitable material for application in LD-CLSM mixtures.

Mixtures with TOSW showed higher drying shrinkage as the content of TOSW increases), therefore it is recommended to use shrinkage control admixtures for applications where shrinkage control is required. FIG. 19 is a photograph of cementitious grout incorporating TOSW.

Incorporating TOSW in CLSM mixtures has significantly reduced bleed water.

Incorporating TOSW in CLSM mixtures lowered the pollutant potential of the TOSW in terms of leaching of heavy metals with concentrations within the limits of the groundwater standard of the Canadian Council of Ministers of Environment (CCME).

The unconfined compressive strength at 28 days of the tested CLSM mixtures ranged from 0.6 MPa to 4.7 MPa for control mixtures with different cement content and from 2.8 MPa to 6.8 MPa for Group 2 mixtures with different cement and TOSW content. Higher strength values were achieved for mixtures with higher TOSW content within the same group. Replacing fly ash with TOSW in Group 3 mixtures lowered the strength and elastic modulus of the mixtures compared to the control mixtures, which may be beneficial in some applications of CLSM where low strength is required for future excavation. Higher cement content can compensate for the reduced strength due to elimination of fly ash. Increasing cement content from 60 kg/m3 to 90 kg/m³ increased the CLSM mixture strength from 423 kPa to 1233 kPa.

Finally, fly ash can be replaced by TOSW in CLSM mixtures while maintaining the properties for CLSM within the limits of ACI committee 229 report. As noted above, the mechanical properties of CLSM formulations have been deliberately kept low so that it can be excavated easily. However, due to its pozzolanic nature, the use of fly ash to maintain high flowability will increase later ages strength making re-excavation a problem. Thus, very advantageously the use of the very fine SiO₂ TOSW particles allows the production of flowable CLSM formulations at early ages and is easy to excavate at later ages.

### Concrete Formulations

### Materials

Ordinary Portland cement (OPC) Type 10 was used in all mixtures as the main binder. It consisted of 61% Tricalcium silicate (3CaOSiO₂), 11% Dicalcium silicate (2CaOSiO₂), 9% Tri-calcium aluminate (3CaOAl₂O₃), 7% tetracalcium aluminoferrite (4CaOAl₂O₃Fe₂O₃)), 3% sulfur trioxide (SO₃) and 0.82% equivalent alkalis was used as a binder material. TOSW was added as partial replacement of sand by volume. Table 10 shows the trace elements of TOSW. Particle size distribution curves for OPC and TOSW are shown in FIG. 2 as previously discussed.

TABLE 10
Analysis of the TOSW

| | | ICP-AES Analysis |
|---|---|---|
| Element | Symbol | (μg/g) |
| Silver | Ag | <0.05 |
| Aluminum | Al | 7399 |
| Arsenic | As | 20 |
| Barium | Ba | 4795 |
| Cadmium | Cd | <0.05 |
| Cobalt | Co | 5 |
| Copper | Cu | 13 |
| Iron | Fe | 14024 |
| Manganese | Mn | 201 |
| Molybdenum | Mo | <0.05 |
| Nickel | Ni | 25 |
| Vanadium | V | 30 |
| Zinc | Zn | 101 |
| Lithium | Li | 4 |
| Lead | Pb | 33 |

Coarse aggregate was a washed round gravel with sizes 5 to 10 mm, absorption of 0.8% and fines content lower than 1%. Natural siliceous sand with an absorption of 1.5% was used as fine aggregates. A water to cement ratio of 0.42 was used in all tested mixtures. A polycarboxylate ether based superplasticizer (HRWRA) was used to adjust mixture flowability. Air entraining admixture complying with ASTM C260 was used. In order to satisfy strength, workability and durability requirements for CFA piles, all mixtures were designed to achieve a slump of 220 mm±50 mm and minimum 28-day compressive strength of 35 MPa. Table 11 shows the composition for all tested mixtures.

TABLE 11
Mixtures composition

| | | 10% | 20% | 30% | 40% |
|---|---|---|---|---|---|
| Property | Control | TOSW | TOSW | TOSW | TOSW |
| Cement | 1 | 1 | 1 | 1 | 1 |
| Sand | 1.79 | 1.6 | 1.42 | 1.24 | 1.07 |
| Gravel | 2.45 | 2.45 | 2.45 | 2.45 | 2.45 |
| TOSW (%) | 0 | 10 | 20 | 30 | 40 |
| Superplasticizer (%) | 0.80% | 0.85% | 1.0% | 1.15% | 1.6% |
| Air entrainment (%) | 0.05 | 0.05 | 0.05 | 0.05 | 0.05 |
| Slump (mm) | 225 | 225 | 220 | 220 | 215 |
| Concrete temperature | 17 | 18 | 18 | 23 | 23 |
| (C. °) | | | | | |
| Air temperature (C. °) | 22 | 24 | 24 | 23 | 23 |

### Testing Procedures

### Fresh Properties

Slump and bleeding tests were conducted according to ASTM C143 (Standard Test Method for Slump of Hydraulic-Cement Concrete) and ASTM C232 (Standard Test Method for Bleeding of Concrete) to evaluate fresh properties for concrete mixtures, respectively. Moreover, the slump retention for concrete mixtures was conducted by measuring the slump loss at specific time intervals over the investigated period.

### Hardened Properties

Mechanical properties including compressive and tensile strengths, and modulus of elasticity were evaluated according to ASTM C39, ASTM C496, respectively. Flexural strength was evaluated using 100×100×400 mm specimens according to ASTM C78. In addition, the bond strength between the concrete and the rebar was evaluated by pulling a steel rebar out of the 150×300 mm concrete cylinder. All specimens were produced in triplicate and were cured in a moist curing room (i.e. temperature (T)=23° C.±2° C. and relative humidity (RH)=95%±5%) until testing ages 7, 28 and 120 days.

### Durability Performance

Freezing and thawing test was conducted on prismatic concrete specimens following ASTM C666. Initially, specimens were inserted in metal boxes and then water was added up to 3 mm above the upper face of the concrete specimens (Method A of ASTM C666). Specimens were subjected to the freeze and thaw cycles adjusted according to ASTM C666 inside a freeze and thaw chamber. Meanwhile, non-destructive ultrasonic pulse velocity test was performed.

For corrosion testing, the electrochemical linear polarization resistance method was utilized to determine the corrosion current density (i_{corr}). In this method, a three-electrode system is used to measure i_{corr}. More details about the test setup can be found elsewhere.

After a suitable initial delay, typically 60 s, the steel was polarized. The product of surface area of rebar under polarization and the slope of applied potential versus measured current plot was taken as the linear polarization resistance Rₚ (kΩ cm²) and icorr (A/cm²) can be calculated using Equation 2:

$${i}_{corr} = \frac{B}{{R}_{P}} \qquad 2$$

B is a constant, in case of steel in passive state, it has a value 52 mV while in case of steel in active state, it has a value of 26 mV. The value of B used in this test was 26 mV. All specimens were exposed to an accelerated scenario adopted from previous study at which specimens were connected to a direct electric current while being immersed in a 3.5% sodium chloride (NaCl) solution.

### Leaching Test

Leaching testing was conducted according to EPA 1315 method (1315, 2013). Test was conducted on an unsolidified sample of TOSW soaked as a row material in a certain volume of water. Simultaneously, concrete specimen with and without TOSW were immerged separately in the same water volume. Water samples were analyzed every 3 days using inductively coupled plasma mass spectrometry (ICP-MS).

### Results and Discussion

### Fresh Properties

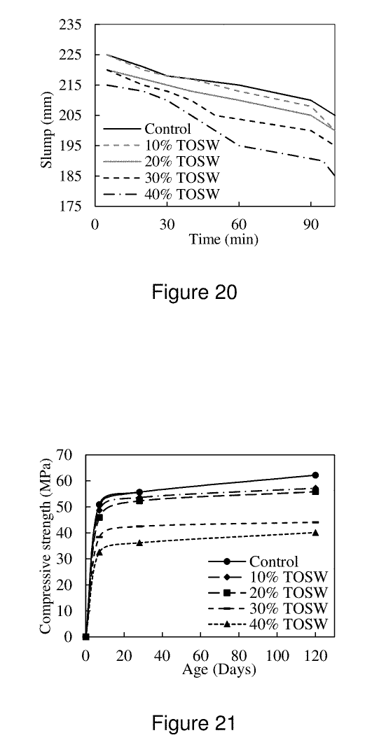

Fresh properties of concrete have a significant effect on its placement quality. Concrete with adequate workability and stability against segregation will have high strength and durability performance. In order to examine the effect of TOSW addition on the workability, all concrete mixtures slump was adjusted to 220±5 mm while monitoring the change in HRWRA demand. Several trial concrete batches were conducted in order to identify the optimum HRWRA dosage that meets the targeted slump. As shown in Table 11, addition of TOSW reduced slump, hence, an increasing in HRWRA dosage was required to maintain the slump within the desired range. For instance, mixture incorporating 20% TOSW required an increase in the HRWRA with about 0.2% to achieve the same slump of that of the control mixture. This can be ascribed to the fact that TOSW is a very fine material which confers a very high viscosity to the fresh mixture leading to a greater cohesivity and lower slump (Frontera, Candamano, lacobini and Crea, 2014). Eventually, all tested mixtures had not shown any sign of segregation or bleeding. On the other hand, from practicality point of view, failing to maintain the concrete workable for at least 30 min can jeopardize the entire installation process of CFA piles. This time frame is required to finish concrete pumping and reinforcement steel cage installation. FIG. 20 illustrates the change in slump with time for all tested mixtures. All concrete mixtures incorporating TOSW had satisfied the 30 minutes' slump retention time and maintained up to 90 min after mixing within the required slump range for CFA piles. Therefore, mixtures incorporating TOSW can be used successfully for CFA application from workability point of view.

### Compressive Strength

Compressive strength results for control and TOSW mixtures are given in FIG. 21. Compressive strength had decreased by the addition of TOSW as partial replacement of sand. The higher the replacement rate, the greater was the reduction in the compressive strength. For instance, adding 10% and 30% of TOSW had induced a reduction in the compressive strength at age 28 days with about 4% and 16% than that of the control mixture, respectively. This reduction in strength can be ascribed to the increase in the amount of fine materials in mixtures (i.e. TOSW addition). Simultaneously, inadequate dispersion of TOSW particles due to coagulation could induce weak points in the concrete microstructure resulting in a lower achieved strength. However, all tested mixtures meet the targeted compressive strength for CFA pile concrete mixtures at age 28 days (i.e. 35 MPa), except mixture incorporating 40% TOSW. For instance, compressive strength at age 28 days for mixtures incorporating 20% and 30% were 52.31 MPa and 46.75 MPa, respectively. It is interesting to note that the development rate of concrete strength did not alter by the addition of TOSW. The increase in compressive strength for mixture with and without TOSW from age 7 to 28 days and from 28 to 120 days was about 10%±1% and 12%±2%, respectively.

### Splitting Tensile Strength

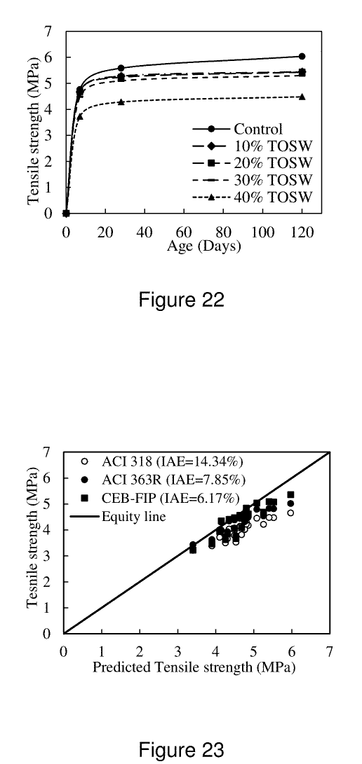

FIG. 22 illustrates the variation of splitting tensile strength with time for all tested mixtures. Tensile strength results followed the same trend as that of compressive strength results. The higher the replacement rate, the greater was the reduction in the tensile strength. For instance, adding 10% and 40% of TOSW had induced a reduction in the tensile strength at age 28 days with about 6% and 23% than that of the control mixture, respectively. Similar to compressive strength, addition of TOSW had insignificant effect on the development rate of the tensile strength. All mixtures with and without TOSW had tensile strength developing rate of about 14% from age 7 to 28 days and less than 10% from age 28 to 120 days.

Generally, the ratio between tensile and compressive strengths for mixtures with and without TOSW at different concrete ages was about 10% which is a common value in the literature. Moreover, several national building codes had proposed various formulas for the relationship between splitting tensile and compressive strengths for concrete. In this study, ACI 318 (318, 2008), ACI 363R (ACI, 2010) and CEB-FIP (Taerwe and Matthys, 2013) formulas were used to predict the TOSW mixture splitting tensile. The general formula is as follows (Equation 3):

fₜₛₚ=af_{c}^{b} 3

Where, fₜₛₚ=splitting tensile strength, and f_{c}=compressive strength, in MPa, a and b are constants (i.e. ACI 318: a=0.56, b=0.50; ACI 363R: a=0.59, b=0.50; and CEB-FIP: a=0.3, b=0.67). The deviation between experimental data and predicted values is assessed statistically based on the integral absolute error (IAE, %), and it is computed from the following equation (Equation 4):

$$IAE = \sum \frac{Q - P}{\sum Q} \times 100 \% \qquad 4$$

Where, Q=observed value and P=predicted value. The IAE value reflects the difference between predicted and observed values. If IAE is zero, this indicates that the predicted and observed values are identical, which is rarely occurred. Hence, if there are different regression equations, the one having the smallest value of the IAE is the most reliable. Generally, an acceptable regression equation will have IAE in the range from 0 to 10%.

FIG. 23 illustrates the correlation between the experimental data and predicted values for the splitting tensile strength. It seems that all the proposed formulas underestimate the splitting tensile strength of concrete mixtures incorporating TOSW. However, IAE values for CEB-FIP and ACI 363R were less than 10%, hence, both equations can be used to estimate the splitting tensile strength of TOSW concrete mixtures based on the achieved compressive strength.

### Flexural Strength

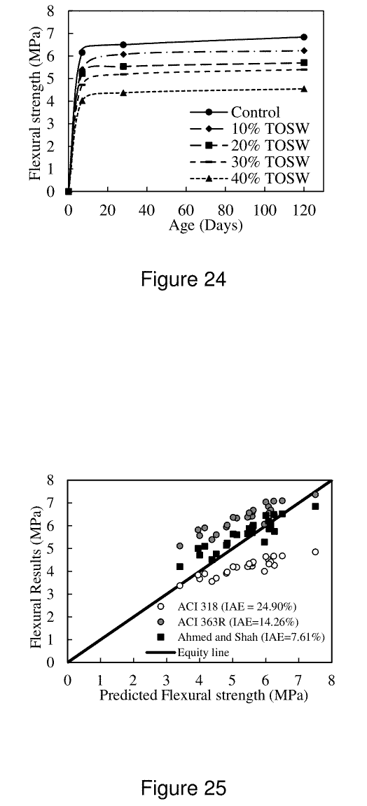

FIG. 24 shows the development of the flexural strength with time. It is clear that flexural strength results were consistent with compressive and tensile strength results. The flexural strength for control mixture was around 13%±1% of its compressive strength at all testing ages. Similar trend was exhibited by mixtures incorporating different contents of TOSW. For instance, ratios between the flexural and compressive strength for mixtures incorporating 20% and 40% of TOSW were 11.6% and 13.2% at age 28 days, respectively.

Similar to splitting tensile strength, various formulas for the relationship between flexural and compressive strengths were adopted. The ACI 318, ACI 363R and formula proposed by Shah and Ahmad (Shah and Ahmad, 1985) were used to predict the TOSW mixture flexural strength. The general formula is similar to that in Equation 3 as follows in Equation 5:

f_{f}=af_{c}^{b} 5

Where, f_{f}=flexural strength, and f_{c}=compressive strength, in MPa, a and b are constants (i.e. ACI 318: a=0.62, b=0.50; ACI 363R: a=0.94, b=0.50; and Ahmad and Shah (1985): a=0.44, b=0.67). The deviation between experimental data and predicted values was also assessed on the basis of IAE (%). FIG. 25 shows the correlation between the experimental data and predicted values for the flexural strength. It can be seen that Eq. 5 is capable to predict the flexural strength for mixtures incorporating TOSW with an acceptable accuracy (i.e. IAE less than 10%).

### Modulus of Elasticity

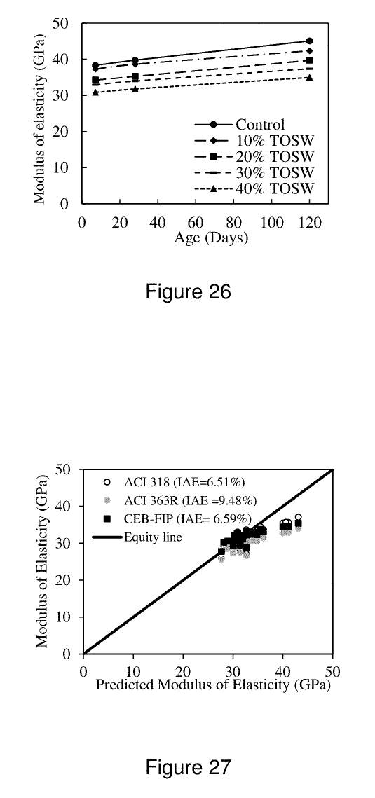

The modulus of elasticity of concrete (E) represents the relationship between the stress and strain and provides an understanding of their effect on each other. As shown in FIG. 26, increasing the TOSW content leads to a reduction in the measured modulus of elasticity. For instance, at age 28 days, increasing the TOSW content from 10% to 30% resulted in a higher reduction in the modulus of elasticity with about 12%. Moreover, the reduction in the modulus of elasticity induced by TOSW addition was in the same reduction order of that of the compressive strength. This is in agreement with the literature as concrete modulus of elasticity is strongly related to its compressive strength. Generally, in the quality control program, modulus of elasticity is expressed as function of compressive strength which is determined routinely, while modulus of elasticity test is ignored as it is laborious and time-consuming. Therefore, various researchers have proposed a number of expressions that can be categorized into two groups. The first group of expressions may be written in the general formula as shown in (Equation 6):

E=af_{c}^{b}+c 6

Where a, b, and c are coefficients. This formula is recommended by ACI 363R (a=3320, b=0.5, c=6900). In the second category, the expression is similar to Equation 3. The ACI 318 and CEB-FIP use values of 4730 and 8981 for a coefficient and 0.5 and 0.33 for b coefficient, respectively. FIG. 27 shows the correlation between the experimental data and predicted values for the modulus of elasticity. All proposed formulas are capable to predict the modulus of elasticity for mixtures incorporating TOSW with an acceptable accuracy (i.e. IAE less than 10%).

### Pullout Strength

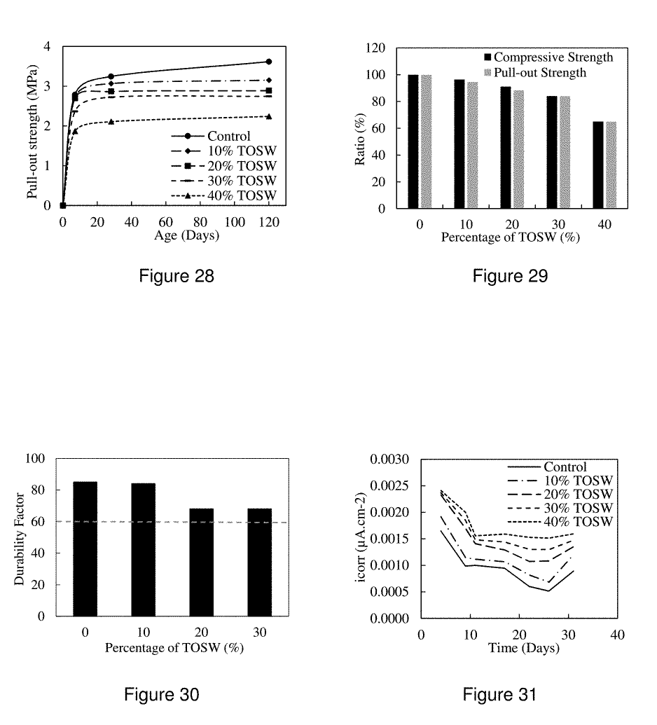

One of the main assumptions in design of reinforced concrete structures is the strain compatibility between concrete and reinforcement steel. Hence, bond between them (i.e. concrete and steel) is an essential parameter which is significantly affected by the quality and properties of the holding concrete (Valcuende and Parra, 2009). FIG. 28 shows pullout strength development for all tested mixtures over the investigated period. All tested mixtures achieved more than 75% of the final pull-out strength at age 7 days. For instance, control mixture and mixture incorporating 30% TOSW exhibited 77% and 87% of their final pull-out strength at age 7 days, respectively. Moreover, the addition of TOSW has resulted in a lower pull-out strength with respect to that of the control mixture without TOSW. The higher the TOSW content, the higher was the reduction in the pull-out strength.

For example, increasing the TOSW content from 10% to 40% had led to a higher reduction in pull-out strength with about 30% with respect to that of the control mixture at age 28 days. FIG. 29 shows the compressive strength and pull-out strength of the tested mixtures at age 28 days as a percentage of the control mixture. The reduction in both compressive and pull-out strengths due to TOSW addition were almost the same. This is expected since the bond behaviour between the rebar and concrete is mainly controlled by concrete mechanical properties (i.e. compressive and tensile strengths).

### Freeze and Thaw

Frost action is among the prominent durability problems of concrete structures exposed to cold climates. Hence, the freeze-thaw resistance for each tested mixtures was assessed according to ASTM C666 in which a durability factor (DF) is calculated after exposing each specimen to a number of freezing and thawing cycles (A equals to M, which is a specified number of cycles at which the exposure is to be terminated (i.e. 300 cycles according to ASTM C666) or until its relative dynamic modulus of elasticity (P) reaches 60% of its initial value using Equation 7:

$$DF = \frac{P \times N}{M} \qquad 7$$

Durability factors for all tested concrete mixtures after 300 freezing and thawing cycles are shown in FIG. 30. All mixtures incorporating TOSW met the 60% threshold recommended by ASTM C666 guidelines for durable concrete subjected to freezing-thawing cycles, except mixture incorporating 40% TOSW. Mixture incorporating 40% TOSW was markedly deteriorated at about 210 freezing-thawing cycles with a durability factor less than 50%.

Generally, the relative dynamic modulus of elasticity was found to decrease as the TOSW content increased. Addition of TOSW reduces the mechanical properties of concrete mixtures, especially tensile strength. Simultaneously, deterioration of concrete exposed to freezing and thawing cycles has been ascribed to the migration of super-cooled water between small and large surface pores in order to freeze and form ice. The gradual build-up of ice in capillary pores exerts tensile stresses. As these tensile stress excessed the cement matrix tensile strength, micro cracks are formed and start to grow and propagate with the repeating of the freeze and thaw cycle. Hence, the addition of TOSW to concrete exposed to forest action makes it more vulnerable to crack due to the reduction in its tensile strength.

### Corrosion

FIG. 31 illustrates the variation of corrosion current density (i_{corr}) with exposure time to NaCl solution for different specimens. It was observed that TOSW addition increases the corrosion current. However, the calculated corrosion current for all mixtures was below the threshold value of 0.10 μA/cm² indicating passive condition according to the criteria developed by Broomfield and Clear (Broomfield, 1996, Clear, 1989).

### Leaching

Concrete mixtures incorporating 40% TOSW did not meet the performance requirements for CFA. Hence, the focus in the leaching evaluation was directed to concrete mixtures incorporating up to 30% of TOSW as partial replacement of sand. Leaching of heavy metals from the TOSW was initially identified through testing a sample of raw TOSW (Table 12). According to the Canadian Council of Ministers of Environment (CCME) guideline limits, incorporation of TOSW in concrete mixtures had significantly reduced the leaching for different metals with respect to raw TOSW as shown in Table 12. For example, incorporation of TOSW in concrete had led to leaching values for Vanadium, Arsenic, Aluminum and Nickel, below CCME standards by about 20% to 93%. This can be ascribed to the solidification of the TOSW in the cementitious matrix of concrete. In addition, the densification and reduction in porosity of concrete microstructure induced by the addition of the very fine TOSW assisted in entrapping higher amount of metals (Sabatini, Knox and American Chemical Society. Division of Colloid and Surface).

TABLE 12
Measured metals in TOSW compared to different standards

| | | CCME* | Raw TOSW | Concrete leaching (mg/l) | | |
|---|---|---|---|---|---|---|
| | | guideline | leaching | 10% | 20% | 30% |
| Element | Symbol | (mg/l) | (mg/l) | TOSW | TOSW | TOSW |
| Silver | Ag | N.A. | 0.005 | 0.005 | 0.004 | 0.003 |
| Aluminum | Al | 5.000^{b} | 1.656 | 0.349 | 0.615 | 0.975 |
| Arsenic | As | 0.005^{a} | 0.012 | 0.004 | 0.002 | BDL* |
| Barium | Ba | N.A. | 1.113 | 0.700 | 0.105 | 0.119 |
| Cadmium | Cd | N.A. | 0.066 | 0.010 | 0.004 | BDL |
| Cobalt | Co | 0.050^{b} | 0.001 | BDL | BDL | BDL |
| Copper | Cu | 0.004^{a} | 0.012 | BDL | BDL | BDL |
| Iron | Fe | 0.300^{a} | 0.451 | 0.028 | 0.013 | 0.004 |
| Manganese | Mn | 0.200^{b} | 0.011 | BDL | BDL | BDL |
| Molybdenum | Mo | 0.073^{a} | 0.056 | 0.005 | 0.005 | 0.004 |
| Nickel | Ni | 0.150^{a} | 0.017 | 0.030 | 0.027 | 0.023 |
| Vanadium | V | 0.100^{b} | 0.038 | 0.026 | 0.018 | 0.011 |
| Zinc | Zn | 0.030^{a} | 0.001 | BDL | BDL | BDL |
| Lithium | Li | 2.500^{b} | 0.013 | 0.023 | 0.025 | 0.024 |
| Lead | Pb | 0.006^{a} | 0.004 | 0.001 | 0.002 | 0.002 |

^{a}CCME (Canadian Council of Ministers of Environment) guide lines for protection of fresh water
^{b}CCME guide lines for protection of agriculture (irrigation)
*BDL: Below Detecting Limits

### CONCLUSIONS

This study provides a new thought about TOSW. It proved experimentally the high potential of recycling/reusing TOSW in concrete mixtures for different construction applications. Besides converting TOSW to a valuable product, this study provides an alternative solution for waste management of TOSW instead of sending to landfill. The following conclusions can be drawn from the above discussed results on concrete containing TOSW particles.

First, increasing the HRWRA dosage can overcome the reduction in concrete slump induced by TOSW addition and maintain its workability within the required range for CFA application. Second, concrete mixtures incorporating up 30% TOSW as a partial replacement of sand met the targeted compressive strength for CFA pile concrete mixtures at age 28 days (i.e. 35 MPa) along with adequate durability performance. Third, addition of TOSW did not alter the correlation between compressive strength and other mechanical properties. Finally, solidification of TOSW in the cementitious matrix of concrete along with reduction in concrete porosity due to TOSW addition increase the potential of producing materials with a lower pollution potential than that characterizing the TOSW disposal.

The use of the TOSW silicon dioxide particles in concrete is very advantageous in that it addresses a fundamental structural problem associated with concrete. Specifically, bleeding is an inherent property of concrete, where water comes out to the surface of the concrete, it being lowest specific gravity among all the ingredients of concrete. Bleeding increases concrete permeability thereby jeopardizing its durability performance, it reduces the bonding between aggregate and cement paste leading to a lower strength, and it also reduces bond between the reinforcement and concrete. Using the very fine SiO₂ waste in concrete formulations as disclosed herein will reduce bleeding significantly as it creates a longer path for the water to traverse and it has a high surface area. Further the inter-particle voids between aggregate particles have adverse effects on concrete strength and durability. Hence, using such very fine SiO₂ waste will fill these voids thereby improving the packing density of the aggregate leading to impermeable strong and durable concrete.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

Ormeloh, J. (2014). Thermomechanical cuttings cleaner—qualification for offshore treatment of oil contaminated cuttings on the Norwegian continental shelf and Martin Linge case study. Norway: Master thesis, University of Stavanger.

Therefore what is claimed is:

1. A method of producing cementitious formulations, comprising:
subjecting oil sands drill cuttings to a process configured for
separating water and hydrocarbons from solid constituents of the oil sands drill cuttings, and
producing treated oil sands waste comprising solid SiO₂ particles having a size distribution in a range from about 0.8 to about 30 microns, and with about 90% of the sample volume below about 9.9 microns; and
mixing said treated oil sands waste comprising said solid SiO₂ particles with constituents used in preselected cementitious formulations used in a preselected geotechnical application, said treated oil sands waste being in an amount of about 10 to about 40% by weight.

2. The method according to claim 1, wherein the process configured for separating water and hydrocarbons from solid constituents of the oil sands drill cuttings is carried out in a thermomechanical cuttings cleaner.

3. The method according to claim 1, wherein the solid SiO₂ particles have a mean size of about 2.7 microns.

4. The method according to claim 1, wherein the preselected cementitious formulation is a grout formulation to be mixed with water, and wherein said grout formulation comprises a mixture of at least cement and water, and wherein said solid SiO₂ particles are used to replace at least some of the cement.

5. The method according to claim 4, wherein the solid SiO₂ particles are used to replace the cement in an amount between about 10 to about 50% by volume.

6. The method according to claim 1, wherein the preselected cementitious formulation is a grout formulation to be mixed with water, and wherein said grout formulation comprises a mixture of at least cement, sand and water, and wherein said solid SiO₂ particles are used to replace at least some of the cement and sand.

7. The method according to claim 6, wherein the solid SiO₂ particles are used to replace the cement in an amount between about 10 to about 30% by volume, and to replace the sand in an amount between about 10 to about 20% by volume.

8. The method according to claim 1, wherein the preselected cementitious formulation is a grout formulation comprising cement to be mixed with water, and wherein said solid SiO₂ particles are used to replace cement from about 0% to about 50% by volume.

9. The method according to claim 1, wherein the preselected cementitious formulation is a concrete formulation to be mixed with water, and wherein said concrete formulation comprises a mixture of at least cement, aggregates and fly ash, and wherein said solid SiO₂ particles are used to replace at least some of the fly ash.

10. The method according to claim 1, wherein the preselected cementitious formulation is a concrete formulation to be mixed with water, and wherein said concrete formulation comprises a mixture of at least cement, aggregates and fly ash, and wherein said solid SiO₂ particles are used to replace all of the fly ash such that said cementitious formulation for the concrete formulation includes cement, aggregates and said solid SiO₂ particles.

11. The method according to claim 1, wherein the preselected cementitious formulation is a concrete formulation to be mixed with water, and wherein said concrete formulation comprises a mixture of at least cement, aggregates and fly ash, and wherein said solid SiO₂ particles are used to replace at least some of the fly ash and some of the cement.

12. The method according to claim 1, wherein the preselected cementitious formulation is a concrete formulation to be mixed with water, and wherein said concrete formulation comprises a mixture of at least cement, aggregates and fly ash, and wherein said aggregates include sand and gravel, and wherein said solid SiO₂ particles are used to replace at least some of the fly ash, some of the sand and some of the cement.

13. The method according to claim 1, wherein the preselected cementitious formulation is a concrete formulation to be mixed with water, and wherein said concrete formulation comprises a mixture of at least cement, aggregates and fly ash, and wherein said aggregates include sand and gravel, and wherein said solid SiO₂ particles are used to replace at least some of the sand and some of the cement, and all of the fly ash.

14. The method according to claim 1, wherein the preselected cementitious formulation is a concrete formulation to be mixed with water, and wherein said concrete formulation comprises a mixture of at least cement, course aggregates, fly ash and sand, and wherein said solid SiO₂ particles are used to replace the sand by about 0 to about 40% by volume, and some or all of the fly ash.

15. The method according to claim 1, wherein the preselected cementitious formulation is a controlled low strength material to be mixed with water, and wherein said controlled low strength material comprises a mixture of at least cement, and fine aggregates, and wherein said solid SiO₂ particles are used to replace at least some of one or both of the cement and fine aggregates.

16. The method according to claim 1, wherein the preselected cementitious formulation is a controlled low strength material to be mixed with water, and wherein said controlled low strength material comprises a mixture of at least cement, fine aggregates, and fly ash, and wherein said solid SiO₂ particles are used to replace at least some of one or all of the cement, fly ash and fine aggregates.

17. The method according to claim 1, wherein the preselected cementitious formulation is a controlled low strength material to be mixed with water, and wherein said controlled low strength material comprises a mixture of at least cement, sand, and fly ash, and wherein said solid SiO₂ particles are used to replace sand by about 0 to about 15% by volume and fly ash by 100%.

18. A cementitious formulation produced by the method of claim 1, comprising:
treated oil sands waste in an amount of about 10 to about 40% by weight, said treated oil sands waste comprising solid SiO₂ particles having a size distribution in a range from about 0.8 to about 30 microns, and with about 90% of the sample volume below about 9.9 microns; and
cementitious constituents.
